(19) United States
(12) Patent Application Publication
(10) Pub. No.: US 2025/0299075 A1
(43) Pub. Date: Sep. 25, 2025

(54) INFORMATION PROCESSING APPARATUS, INFORMATION PROCESSING SYSTEM, INFORMATION PROCESSING METHOD, AND RECORDING MEDIUM

(71) Applicant: Naoyuki SHIMIZU, Kanagawa (JP)

(72) Inventor: Naoyuki SHIMIZU, Kanagawa (JP)

(21) Appl. No.: 19/078,314

(22) Filed: Mar. 13, 2025

(30) Foreign Application Priority Data
Mar. 21, 2024 (JP) 2024-044537
Sep. 10, 2024 (JP) 2024-156535

(51) Int. Cl. G06N 5/04

(52) U.S. Cl. CPC G06N 5/04

(57) ABSTRACT

An information processing apparatus includes circuitry that receives input question data from a terminal apparatus, determines whether a number of answer data obtained based on a question indicated by the input question data is equal to or greater than a predetermined number, outputs to the terminal apparatus answer data, based on a determination that the number of answer data obtained is less than the predetermined number, and requests a large-scale language model to generate a question for obtaining additional input question data and output to the terminal apparatus the question for obtaining the additional input question data output from the large-scale language model, based on a determination that the number of answer data obtained is equal to or greater than the predetermined number.

### CROSS-REFERENCE TO RELATED APPLICATIONS

This patent application is based on and claims priority pursuant to 35 U.S.C. § 119 (a) to Japanese Patent Application Nos. 2024-044537, filed on Mar. 21, 2024, and 2024-156535, filed on Sep. 10, 2024, in the Japan Patent Office, the entire disclosure of which is hereby incorporated by reference herein.

### BACKGROUND

### Technical Field

The present disclosure relates to an information processing apparatus, an information processing system, an information processing method, and a recording medium.

### Related Art

The chatbot outputs an answer to a question input by a user. For example, the chatbot obtains an answer from a large-scale language model based on information input by the user.

When the amount of information input from the user is insufficient, a large number of options are obtained as an answer, making it difficult to output an answer that is most desirable to the user.

### SUMMARY

The present disclosure described herein provides an information processing apparatus including circuitry that receives input question data from a terminal apparatus, determines whether a number of answer data obtained based on a question indicated by the input question data is equal to or greater than a predetermined number, outputs to the terminal apparatus answer data, based on a determination that the number of answer data obtained is less than the predetermined number, and requests a large-scale language model to generate a question for obtaining additional input question data and output to the terminal apparatus the question for obtaining the additional input question data output from the large-scale language model, based on a determination that the number of answer data obtained is equal to or greater than the predetermined number.

The present disclosure described herein provides an information processing system including: the above-described information processing apparatus and the terminal apparatus that communicates with the information processing apparatus via a network, and including circuitry that displays, on a display, the question for obtaining the additional input question data.

The present disclosure described herein provides an information processing method including: receiving input question data; determining whether a number of answer data obtained based on a question indicated by the input question data is equal to or greater than a predetermined number; outputting answer data, based on a determination that the number of answer data obtained is less than the predetermined number; and outputting a question for obtaining additional input question data output from a large-scale language model in response to a request for generating the question for obtaining additional input question data, based on a determination that the number of answer data obtained is equal to or greater than the predetermined number.

The present disclosure described herein provides a non-transitory recording medium storing a plurality of instructions which, when executed by one or more processors, cause the processors to perform an information processing method receiving input question data; determining whether a number of answer data obtained based on a question indicated by the input question data is equal to or greater than a predetermined number; outputting answer data, based on a determination that the number of answer data obtained is less than the predetermined number; and outputting a question for obtaining additional input question data output from a large-scale language model in response to a request for generating the question for obtaining additional input question data, based on a determination that the number of answer data obtained is equal to or greater than the predetermined number.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a chat system;

FIG. 2 is a diagram illustrating an example hardware configuration of an information processing apparatus;

FIG. 3 is a diagram illustrating a hardware configuration of a terminal apparatus;

FIG. 4 is a table illustrating an example question and answer database (DB);

FIG. 5 is a diagram illustrating functional configurations of apparatuses or devices included in the chat system of FIG. 1;

FIG. 6 is a sequence diagram illustrating operation performed by the chat system of FIG. 1;

FIG. 7 is a diagram illustrating an example prompt;

FIG. 8A is a first diagram illustrating an example screen displayed by the terminal apparatus of FIG. 1;

FIG. 8B is a second diagram illustrating an example screen displayed by the terminal apparatus of FIG. 1;

FIG. 8C is a third diagram illustrating an example screen displayed by the terminal apparatus of FIG. 1;

FIG. 8D is a fourth diagram illustrating an example screen displayed by the terminal apparatus of FIG. 1;

FIG. 9 is a fifth diagram illustrating an example screen displayed by the terminal apparatus of FIG. 1;

FIG. 10A is a sixth diagram illustrating an example screen displayed by the terminal apparatus of FIG. 1;

FIG. 10B is a seventh diagram illustrating an example screen displayed by the terminal apparatus of FIG. 1;

FIG. 10C is an eighth diagram illustrating an example screen displayed by the terminal apparatus of FIG. 1;

FIG. 11 is a diagram illustrating an example of a system configuration of a chat system;

FIG. 12 is a table illustrating an example document DB;

FIG. 13 is a diagram illustrating functional configurations of apparatuses or devices included in the chat system of FIG. 11;

FIG. 14 is a sequence diagram illustrating an example operation performed by the chat system of FIG. 11

FIG. 15 is a diagram illustrating an example screen displayed by the terminal apparatus of FIG. 11;

FIG. 16 is a diagram illustrating an example prompt;

FIG. 17 is a diagram illustrating an example prompt;

FIG. 18 is a diagram illustrating an example of a system configuration of a chat system;

FIG. 19 is a table illustrating an example conversation history DB;

FIG. 20 is a table illustrating an example user information DB;

FIG. 21 is a diagram illustrating functional configurations of the apparatuses or devices included in the chat system of FIG. 18;

FIG. 22 is a sequence diagram illustrating an example operation performed by the chat system of FIG. 18;

FIG. 23 is a first diagram illustrating an example screen including output answer data, displayed by the terminal apparatus of FIG. 18;

FIG. 24 is a second diagram illustrating an example screen including output answer data, displayed by the terminal apparatus of FIG. 18;

FIG. 25 is a third diagram illustrating an example screen including output answer data, displayed by the terminal apparatus of FIG. 18; and

FIG. 26 is a fourth diagram illustrating an example screen including output answer data, displayed by the terminal apparatus of FIG. 18.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Example

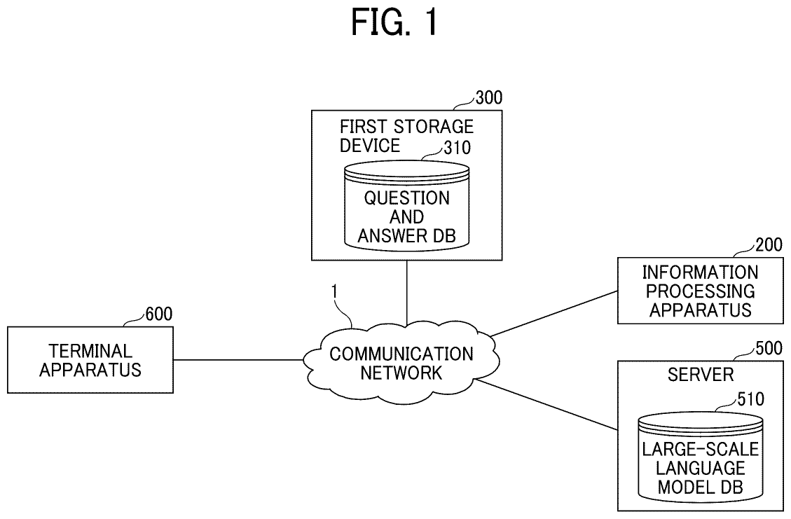

The first example is described below with reference to FIGS. 1 to 10C. FIG. 1 is a diagram illustrating a system configuration of a chat system 100 according to the first example.

The chat system 100 includes an information processing apparatus 200, a first storage device 300, a server 500, and a terminal apparatus 600, which are connected to each other via a communication network 1. The chat system 100 is an example of an information processing system.

In the chat system 100, the information processing apparatus 200, the first storage device 300, and the server 500 operate in cooperation to provide a chatbot service to a user of the terminal apparatus 600.

When a question is input at the terminal apparatus 600, the information processing apparatus 200 refers to a question and answer DB 310 stored in the first storage device 300, and outputs to the terminal apparatus 600 an answer to the question that is input.

The first storage device 300 includes the question and answer DB 310. The question and answer DB 310, which is an example of a question and answer storage unit, stores question and answer information in which questions and answers are associated with each other. The question and answer DB 310 is an example of sets of question and answer information in which question data indicating a question and answer data indicating an answer are associated with each other. The question and answer information, which are previously stored in the question and answer DB 310, may be managed by each tenant that uses the chat system 100. In the following description, the question data included in the question and answer information stored in the question and answer DB 310 is referred to as registered question data, and the answer data included in the question and answer information is referred to as registered answer data.

The server 500 includes a large-scale language model DB 510, and operates as generative artificial intelligence (AI). The generative AI generates text corresponding to a prompt being input, and outputs the generated text to the information processing apparatus 200. Chat Generative Pretrained Transformer (GPT) is one example of the generative AI. The prompt is text data that describes an instruction or a question to the server 500 operating as the generative AI. The large-scale language model will be described in detail below. The terminal apparatus 600 is operated, for example, by the user who uses the chat system 100. More specifically, the terminal apparatus 600 transmits, to the information processing apparatus 200, question data indicating a question to the chat system 100. The terminal apparatus 600 displays answer data indicating an answer to the question indicated by the input question data, which is output from the information processing apparatus 200, in association with the input question data.

In the following description, the question data transmitted from the terminal apparatus 600 to the information processing apparatus 200 and input to the information processing apparatus 200 is referred to as the input question data. In the following description, the answer data output from the information processing apparatus 200 to the terminal apparatus 600 is referred to as the output answer data.

The terminal apparatus 600 may be, for example, a smartphone or a tablet terminal.

In the chat system 100, when the input question data is input, the information processing apparatus 200 determines whether information obtained from the input question data has an amount of information that is sufficient to generate the output answer data.

When the amount of information obtained from the input question data is insufficient, the information processing apparatus 200 outputs, to the server 500, a prompt for requesting generation of an additional question for causing the user to input further information.

The information processing apparatus 200 acquires, from the server 500, output data output from the large-scale language model included in the server 500. The output data output from the large-scale language model is, for example, text data indicating the additional question for causing the user to input further information in relation to the input question data.

In other words, the output data output from the large-scale language model is text data for prompting the input of additional information regarding the contents of the question indicated by the input question data.

In the following description, the output data output from the large-scale language model may be referred to as counter-question data.

When the information processing apparatus 200 acquires the output data from the server 500, the information processing apparatus 200 causes the terminal apparatus 600 to display the acquired output data and prompts the user of the terminal apparatus 600 to input further information.

In the chat system 100, this operation is repeated until a sufficient amount of information is obtained so that the output answer data is generated.

Accordingly, a large amount of information are input in addition to the input question data that is input first, thus preventing an answer that is not intended by the user from being presented to the user. With the additional question that causes the user to input further information, the chat system 100 can output an appropriate response, which is intended by the user.

In the example of FIG. 1, the information processing apparatus 200 and the first storage device 300 are illustrated as separate devices, but any one of these apparatuses or devices may be combined into one apparatus or device. For example, the first storage device 300 may be included in the information processing apparatus 200.

In FIG. 1, the information processing apparatus 200 may be implemented by one or more information processing apparatuses, such that a plurality of information processing apparatuses 200 may be illustrated.

An example hardware configuration of each apparatus or device included in the chat system 100 is described below.

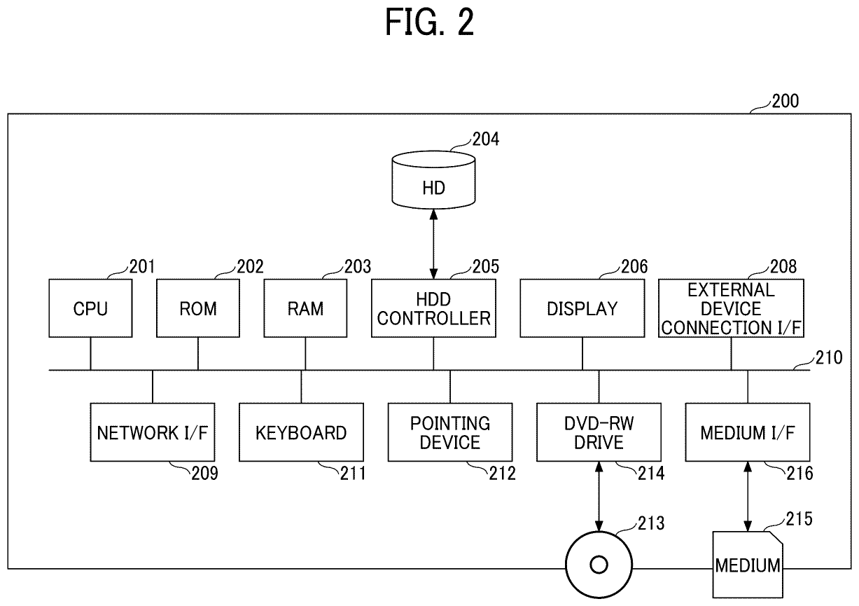

The information processing apparatus 200, the first storage device 300, and the server 500 are each implemented by the general-purpose computer. As an example, a hardware configuration of the information processing apparatus 200 is described below with reference to FIG. 2.

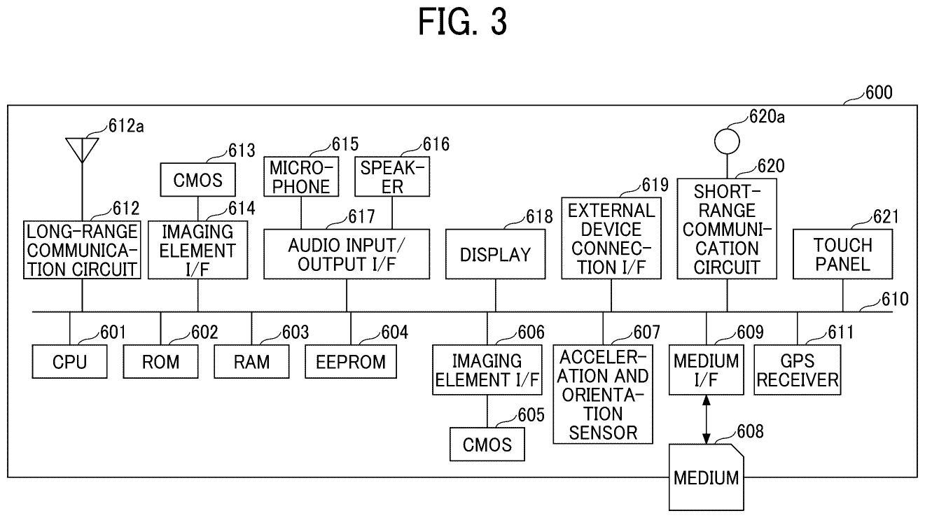

The terminal apparatus 600 is implemented by a smartphone. An example hardware configuration of the terminal apparatus 600 is described below with reference to FIG. 3.

FIG. 2 is a diagram illustrating an example hardware configuration of the information processing apparatus 200. The information processing apparatus 200 illustrated in FIG. 2, which is implemented by a computer, includes a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a Digital Versatile Disk Rewritable (DVD-RW) drive 214, and a medium I/F 216.

The CPU 201 controls entire operation of the information processing apparatus 200. The ROM 202 stores a program such as an initial program loader (IPL) to boot the CPU 201. The RAM 203 is used as a work area for the CPU 201. The HD 204 stores various data such as a control program. The HDD controller 205 controls reading and writing of various data from and to the HD 204 under control of the CPU 201. The display 206 displays various information such as a cursor, menu, window, character, or image. The external device connection I/F 208 is an interface circuit that connects the computer to various external devices. Examples of the external devices include, but not limited to, a universal serial bus (USB) memory and a printer.

The network I/F 209 is an interface circuit that controls communication of data with various external devices through a communication network. The bus line 210 is an address bus or a data bus, which electrically connects the elements illustrated in FIG. 2 such as the CPU 201.

The keyboard 211 serves as an input device, and provided with a plurality of keys that allow a user to input characters, numerals, or various instructions. The pointing device 212 also serves as an input device, and allows a user to select or execute a specific instruction, select a target for processing, or move a cursor being displayed. The DVD-RW drive 214 reads and writes various data from and to a DVD-RW 213, which is an example of a removable storage medium. The removable storage medium is not limited to the DVD-RW and may be a digital versatile disc-recordable (DVD-R), for example. The medium I/F 216 controls reading or writing (storing) of data from or to a storage medium 215 such as a flash memory.

FIG. 3 is a diagram illustrating a hardware configuration of the terminal apparatus 600. The terminal apparatus 600 includes a CPU 601, a ROM 602, a RAM 603, an electrically erasable and programmable ROM (EEPROM) 604, a complementary metal oxide semiconductor (CMOS) sensor 605, an imaging element I/F 606, an acceleration and orientation sensor 607, a medium I/F 609, and a global positioning system (GPS) receiver 611.

The CPU 601 is an arithmetic processing unit, which controls entire operation of the terminal apparatus 600. The ROM 602 stores a control program for controlling the CPU 601, such as an IPL. The RAM 603 is used as a work area for the CPU 601. The EEPROM 604 reads or writes various data such as a control program for a smartphone under control of the CPU 601. The ROM 602, the RAM 603, and the EEPROM 604 are examples of storage devices for the terminal apparatus 600.

The CMOS sensor 605 is an example of a built-in imaging device that captures an object (for example, a self-image of a user operating the terminal apparatus 600) under control of the CPU 601 to obtain image data. In alternative to the CMOS sensor 605, imaging means such as a charge-coupled device (CCD) sensor may be used.

The imaging element I/F 606 is a circuit that controls driving of the CMOS sensor 605. Example of the acceleration and orientation sensor 607 includes an electromagnetic compass or gyrocompass for detecting geomagnetism and an acceleration sensor. The medium I/F 609 controls reading and writing (storing) of data from and to a storage medium 608 such as a flash memory. The GPS receiver 611 receives a GPS signal from a GPS satellite.

The terminal apparatus 600 further includes a long-range communication circuit 612, an antenna 612a for the long-range communication circuit 612, a CMOS sensor 613, an imaging element I/F 614, a microphone 615, a speaker 616, an audio input/output (I/O) I/F 617, a display 618, an external device connection I/F 619, a short-range communication circuit 620, an antenna 620a for the short-range communication circuit 620, and a touch panel 621.

The long-range communication circuit 612 is a circuit that enables the terminal apparatus 600 to communicate with other devices through the communication network. The CMOS sensor 613 is an example of a built-in imaging device that captures an object under control of the CPU 601 to obtain image data. The imaging element I/F 614 is a circuit that controls driving of the CMOS sensor 613. The microphone 615 is a built-in circuit that converts sound into an electrical signal (audio signal). The speaker 616 is a built-in circuit that generates sound such as music or voice by converting an electrical signal into physical vibration. The audio input/output I/F 617 is a circuit for inputting or outputting an audio signal between the microphone 615 and the speaker 616 under control of the CPU 601.

The display 618, which serves as a display means, displays an image of the object, various icons, for example. Examples of the display 618 include a liquid crystal display (LCD) and an organic electroluminescence (EL) display. The external device connection I/F 619 is an interface that connects the terminal apparatus 600 to various external devices. The short-range communication circuit 620 is a communication circuit that communicates in compliance with the near field communication (NFC), the BLUETOOTH, for example. The touch panel 621, which serves as an input device, allows a user to operate the terminal apparatus 600 by touching a screen of the display 618. The display 618 serves as a display unit included in the terminal apparatus 600.

The hardware configuration illustrated in FIG. 3 is one example of the hardware configuration of the terminal apparatus 600, such that the terminal apparatus 600 may have a hardware configuration other than that of FIG. 3. For example, the hardware configuration of the terminal apparatus 600 may be the configuration illustrated in FIG. 2.

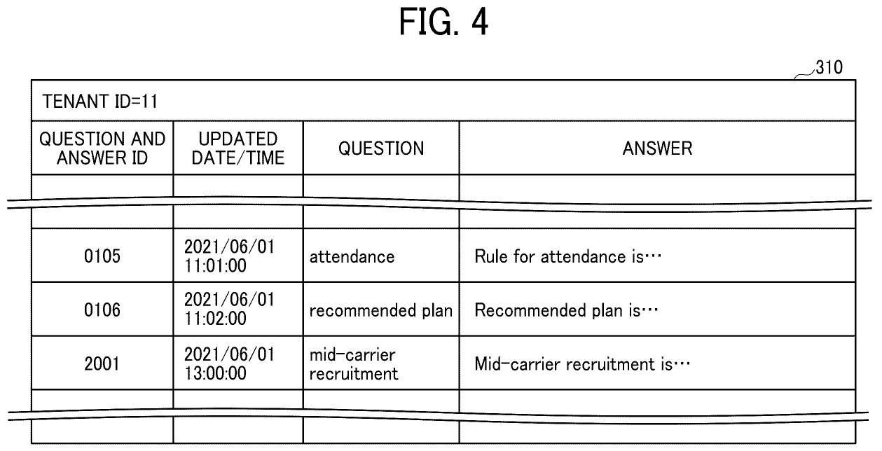

The question and answer DB 310 is described below with reference to FIG. 4. FIG. 4 is a table illustrating the question and answer DB 310.

The question and answer information stored in the question and answer DB 310 may be provided and managed for each tenant. In the example of FIG. 4, the question and answer information managed for the tenant identified with the tenant ID “11” is described.

The question and answer information includes, as data items, a tenant ID, a question and answer ID, an update date and time, a question, and an answer. The items “tenant ID” and the item “question and answer ID” are associated with the other data items. In other words, the question and answer information managed for a particular tenant ID includes a plurality of pieces of question and answer information. Each question and answer information, which is identified with the value of the item “question and answer ID”, has the values of the other items that are associated with the item “question and answer ID”.

The item “question and answer ID” has a value indicating an identifier for identifying question and answer information. The item “update date and time” has a value indicating the date and time when the question and answer information is updated. The item “question” has a value indicating registered question data (text data) representing a question. The item “answer” has a value indicating registered answer data (text data) representing an answer. The values of the item “question” and the item “answer” are previously stored by the administrator for each tenant.

The question and answer information may include other data items such as “contact address” and “link”, in addition to the data items illustrated in FIG. 4. The item “contact address” has a value indicating a contact address to which the user of the terminal apparatus 600 sends an inquiry related to the registered question data. The contact address may be, for example, an email address or a telephone number. The item “link” has a value indicating a link from which information related to the registered question data or the registered answer data is to be obtained.

The items “contact address” and “link” may not be stored in the question and answer DB 310, as long as the question and answer DB 310 stores a set of the registered question data and the registered answer data.

In the case where the first storage device 300 is provided in the information processing apparatus 200, the question and answer information may not be assigned with the tenant ID. In such case, the question and answer information may be referred to only by users who can access the information processing apparatus 200.

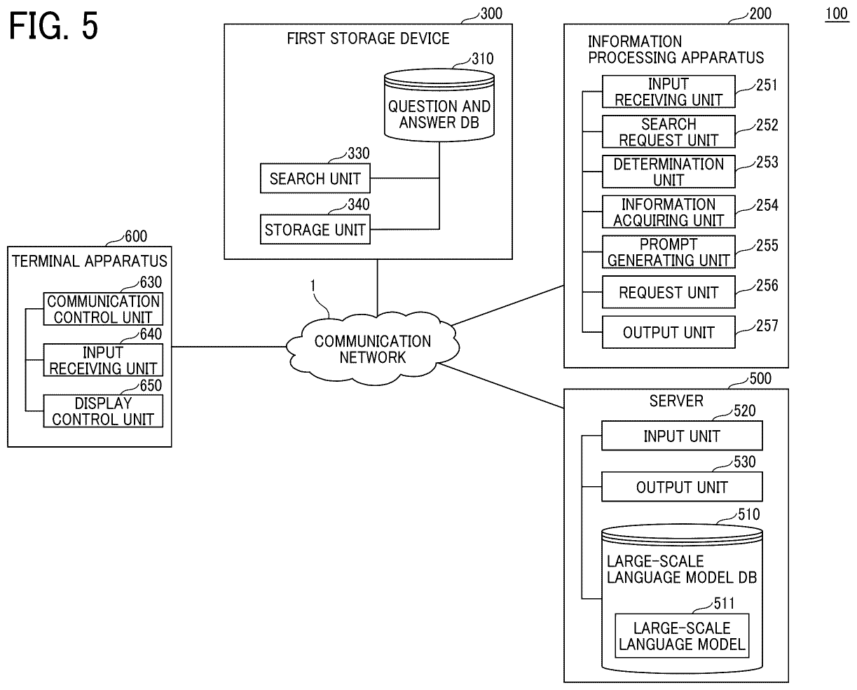

Example functional configurations of apparatus or devices included in the chat system 100 are described below with reference to FIG. 5. FIG. 5 is a diagram illustrating functional configurations of apparatuses or devices included in the chat system 100.

First, the functional configuration of the information processing apparatus 200 is described below. The information processing apparatus 200 includes an input receiving unit 251, a search request unit 252, a determination unit 253, an information acquiring unit 254, a prompt generating unit 255, a request unit 256, and an output unit 257.

The input receiving unit 251 receives various inputs to the information processing apparatus 200. Specifically, the input receiving unit 251 receives inputs of input question data from the terminal apparatus 600.

The search request unit 252 requests the first storage device 300 to conduct search. Specifically, the search request unit 252 transmits, to the first storage device 300, a search request for searching the question and answer DB 310 using the input question data as a search key.

The determination unit 253 determines whether the information obtained using the input question data has a sufficient amount of information that is sufficient to generate the output answer data, based on the search result obtained by the search request unit 252 in response to the search request to the first storage device 300.

In other words, the determination unit 253 determines whether the amount of information obtained from the question and answer DB 310 of the first storage device 300 based on the input question data is equal to or greater than a predetermined amount of information.

For example, the determination unit 253 may determine that the amount of information obtained as a search result is equal to or greater than the predetermined amount of information, when more than one registered answer data is obtained as a result of searching the question and answer DB 310 of the first storage device 300.

The case where the amount of information obtained as the search result is equal to or greater than the predetermined amount of information is, for example, a case where the information obtained from the input question data is insufficient so that the registered answer data that matches the input question data cannot be specified.

When two or more options (records) of the registered answer data are acquired as a result of searching the question and answer DB 310, the determination unit 253 may determine that the information obtained from the input question data is insufficient.

On the other hand, when only one option of the registered answer data is acquired as a result of searching the question and answer DB 310, the determination unit 253 may determine that the information obtained from the input question data is sufficient.

The information acquiring unit 254 acquires, from the first storage device 300, the search result corresponding to the search request from the search request unit 252. In other words, the information acquiring unit 254 acquires the question and answer information, which is the search result, from the first storage device 300.

The prompt generating unit 255 generates a prompt to be output to the server 500. For example, when the determination unit 253 determines that the information obtained from the input question data is insufficient, the prompt generating unit 255 generates a prompt for requesting the server 500 to generate a question that causes the user to input further information.

The request unit 256 outputs the prompt generated by the prompt generating unit 255 to the server 500. In other words, the request unit 256 makes the request to the large-scale language model 511 based on the prompt. For the descriptive purposes, the process of making the request based on the prompt to the large-scale language model 511 and the process of transmitting the prompt generated by the prompt generation unit 255 to the server 500 may be used interchangeably. The output unit 257 outputs various kinds of information from the information processing apparatus 200.

The functional configuration of the first storage device 300 is described below. The first storage device 300 includes the question and answer DB 310, a search unit 330, and a storage unit 340. The search unit 330 searches the question and answer DB 310 in response to a search request from the information processing apparatus 200, and transmits a search result to the information processing apparatus 200. The storage unit 340 stores the input question data and the output answer data in the question and answer DB 310, for example, when the input question data is input and the output answer data is output.

The functional configuration of the server 500 is described below. The server 500 includes the large-scale language model DB 510, an input unit 520, and an output unit 530.

The large-scale language model DB 510 stores the large-scale language model 511 for implementing the generative AI.

The large-scale language model 511 is a computer language model that is generated by executing a learning process using an enormous amount of unlabeled text as learning data and is developed on an artificial neural network having a large number of parameters. The large-scale language model 511 has been sufficiently trained with any desired method for learning a context, such as the next sentence prediction or the masked language model, to capture many of syntax and meanings of human words.

The next sentence prediction understands the context by determining whether a sentence 1 and a sentence 2 are continuous. The masked language model understands the context by masking a word in a sentence and predicting the masked word from the words before and after the masked word.

The input unit 520 inputs a prompt transmitted from the information processing apparatus 200 to the large-scale language model 511. The output unit 530 outputs (transmits) output data output from the large-scale language model 511 to the information processing apparatus 200. In other words, the output unit 530 transmits the output answer data output from the large-scale language model 511 to the information processing apparatus 200.

The functional configuration of the terminal apparatus 600 is described below. The terminal apparatus 600 includes a communication control unit 630, an input receiving unit 640, and a display control unit 650.

The communication control unit 630 controls communication between the terminal apparatus 600 and the information processing apparatus 200. The input receiving unit 640 receives an input to the terminal apparatus 600. The display control unit 650 controls display at the terminal apparatus 600.

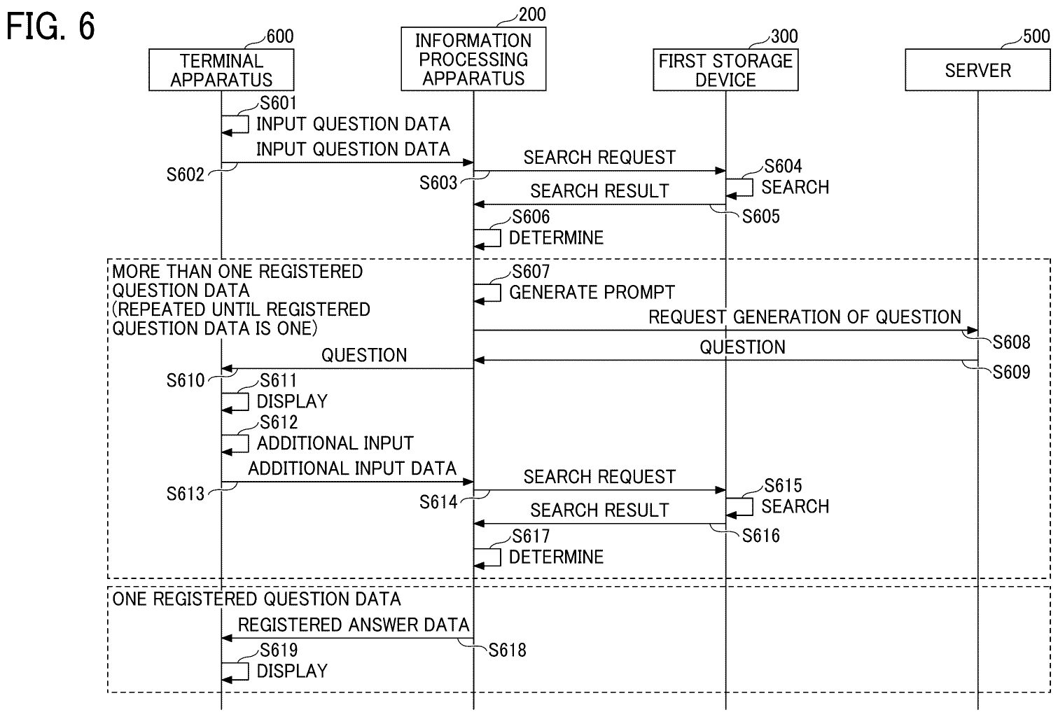

An example operation performed by the chat system 100 is described below with reference to FIG. 6. FIG. 6 is a sequence diagram illustrating operation performed by the chat system 100 of FIG. 5.

The operation illustrated in FIG. 6 is performed when the user of the terminal apparatus 600 has logged in to the chat system 100, for example, using his or her user ID or the tenant ID of a tenant to which the user belongs.

In the chat system 100, when the input receiving unit 640 receives an input of question data at S601, the terminal apparatus 600 transmits the input question data to the information processing apparatus 200 at S602. The input question data being transmitted may be assigned with the tenant ID identifying the tenant to which the user operating the terminal apparatus 600 belongs.

At S603, in response to receiving the input question data by the input receiving unit 251, the search request unit 252 of the information processing apparatus 200 transmits a search request including the tenant ID to the first storage device 300.

When the first storage device 300 receives the search request, at S604, the search unit 330 searches the question and answer DB 310 to obtain a search result. At S605, the search unit 330 transmits the search result to the information processing apparatus 200. Specifically, the first storage device 300 searches the question and answer DB 310 using the input question data as a search key, and transmits a set of the registered question data similar to the input question data and the registered answer data associated with the registered question data to the information processing apparatus 200 as a search result.

When the information acquiring unit 254 of the information processing apparatus 200 acquires the search result from the first storage device 300, at S606, the determination unit 253 determines whether the registered answer data that is obtained as the search result includes two or more records of the registered answer data. At S606, the determination unit 253 of the information processing apparatus 200 determines whether the amount of information obtained from the input question data input to the information processing apparatus 200 at S602 is sufficient to generate the output answer data.

The case where the number of records of the registered answer data that is obtained as the search result is one is a case where one record of output answer data, which corresponds to one record of input question data, is obtained. Further, it is assumed that the information obtained from the input question data has a sufficient amount of information to generate the output answer data.

Further, the case where two or more records of the registered answer data are obtained as the search result is a case where one record of output answer data, which corresponds to one record of input question data, is obtained. Further, it is assumed that the information obtained from the input question data does not have a sufficient amount of information to generate the output answer data.

When the number of the registered answer data obtained as the search result is one at S606, the information processing apparatus 200 determines that the operation proceeds to S618 described below.

When the number of the registered answer data obtained as the search result is two or more at S606, at S607, the prompt generating unit 255 of the information processing apparatus 200 generates a prompt for requesting generation of a question that causes the user of the terminal apparatus 600 to input further information. Specifically, the prompt generating unit 255 of the information processing apparatus 200 generates a prompt for requesting generation of the counter-question data indicating a counter question.

The prompt being generated includes two or more records of the registered answer data obtained by the information processing apparatus 200 as the search result at S605.

At S608, the information processing apparatus 200 transmits the prompt generated by the prompt generating unit 255 to the server 500. The prompt will be described in detail below.

The input unit 520 of the server 500 inputs the prompt to the large-scale language model 511. At S609, the output unit 530 transmits output data output from the large-scale language model 511 to the information processing apparatus 200 as output answer data. The output data transmitted to the information processing apparatus 200 is a question for causing the user of the terminal apparatus 600 to input further information.

When the information processing apparatus 200 receives an input of output data from the server 500, at S610, the output unit 257 outputs the output data to the terminal apparatus 600. In other words, the information processing apparatus 200 transmits to the terminal apparatus 600 a question for prompting the user of the terminal apparatus 600 to input further information.

At S611, the display control unit 650 of the terminal apparatus 600 displays the output data acquired from the information processing apparatus 200 on the display 618. The terminal apparatus 600 displays the question (counter-question) for prompting the user to input further information.

When the input receiving unit 640 receives an additional input corresponding to the question at S612, the terminal apparatus 600 transmits the additional input data to the information processing apparatus 200 at S613. In the following description, data additionally input by the user is referred to as additional input data. The additional input data is an example of additional input question data.

When the input receiving unit 251 receives the additional input data, at S614, the search request unit 252 of the information processing apparatus 200 outputs a search request based on the input question data and the additional input data to the first storage device 300.

Since the processes from S615 to S617 of FIG. 6 are performed in a substantially similar manner as the processes from S604 to S606 of FIG. 6, the description thereof is omitted.

The processes from S607 to S617 are repeated until the number of the registered answer data acquired as the search result from the first storage device 300 becomes one.

If the number of the registered answer data obtained as the search result is one, at S618, the output unit 257 of the information processing apparatus 200 outputs the obtained registered answer data to the terminal apparatus 600 as the output answer data.

At S619, the display control unit 650 of the terminal apparatus 600 displays the output answer data received from the information processing apparatus 200 on the display 618.

As described above, a question for prompting the user to input additional information is generated until one record of registered answer data is obtained corresponding to one record of input question data. Since the user is encouraged to input more information, the accuracy of the answer to the input question data is improved.

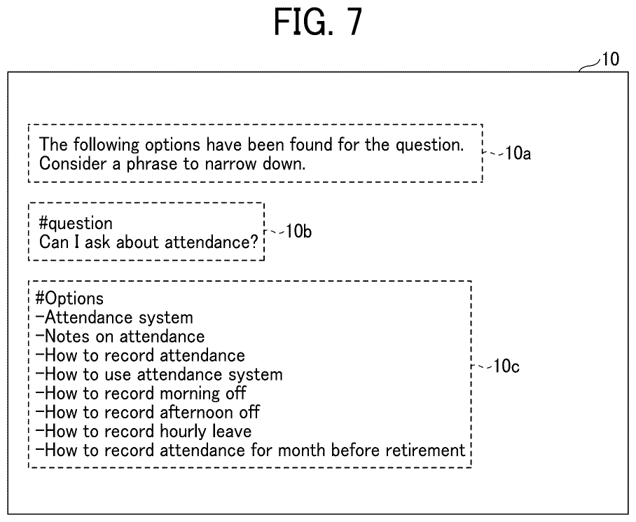

An example prompt generated by the information processing apparatus 200 is described below with reference to FIG. 7.

FIG. 7 is a diagram illustrating an example prompt;

The prompt 10 illustrated in FIG. 7 is an example of the prompt generated at S609 of FIG. 6. The prompt 10 includes text data 10a, text data 10b, and text data 10c.

The text data 10a includes text data indicating that two or more records of registered answer data exist for the input question data. The text data 10a includes text data for requesting generation of a question for requesting the user to input further information to reduce the number of the registered answer data.

The text data 10b includes the input question data. The text data 10c may include the registered question data. The registered question data included in the text data 10c may be registered question data similar to the input question data, which is obtained as a search result of searching the question and answer DB 310 based on the input question data.

As described above, the prompt includes the input question data and the registered question data similar to the input question data. With this prompt, the large-scale language model 511 generates a question for prompting the input of further information to reduce the number of records of the output answer data.

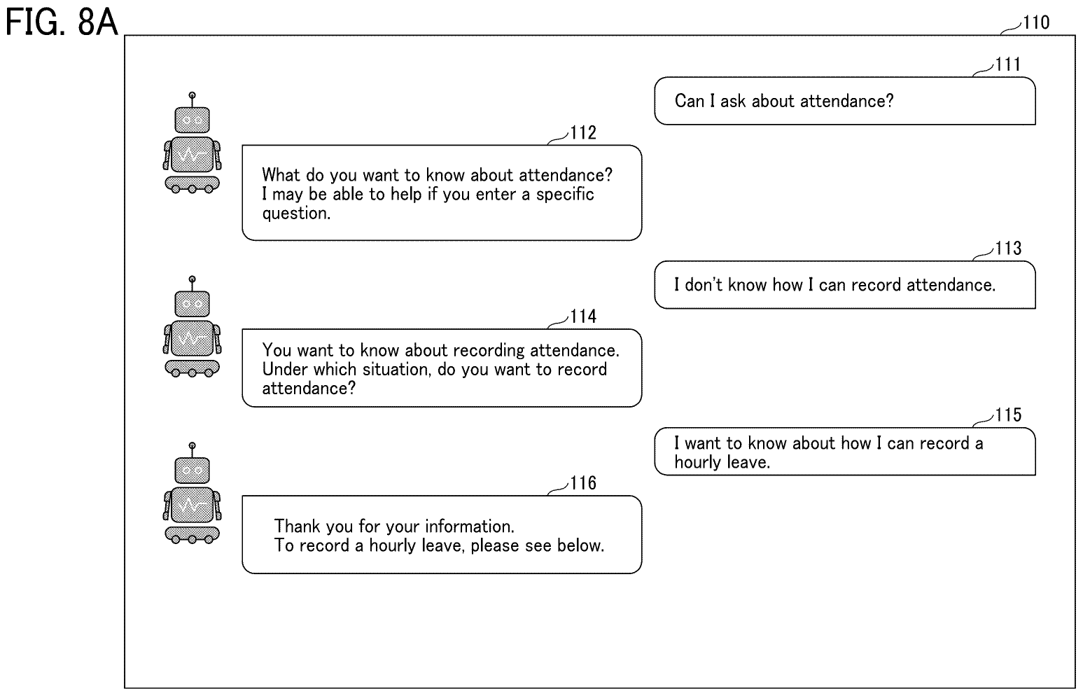

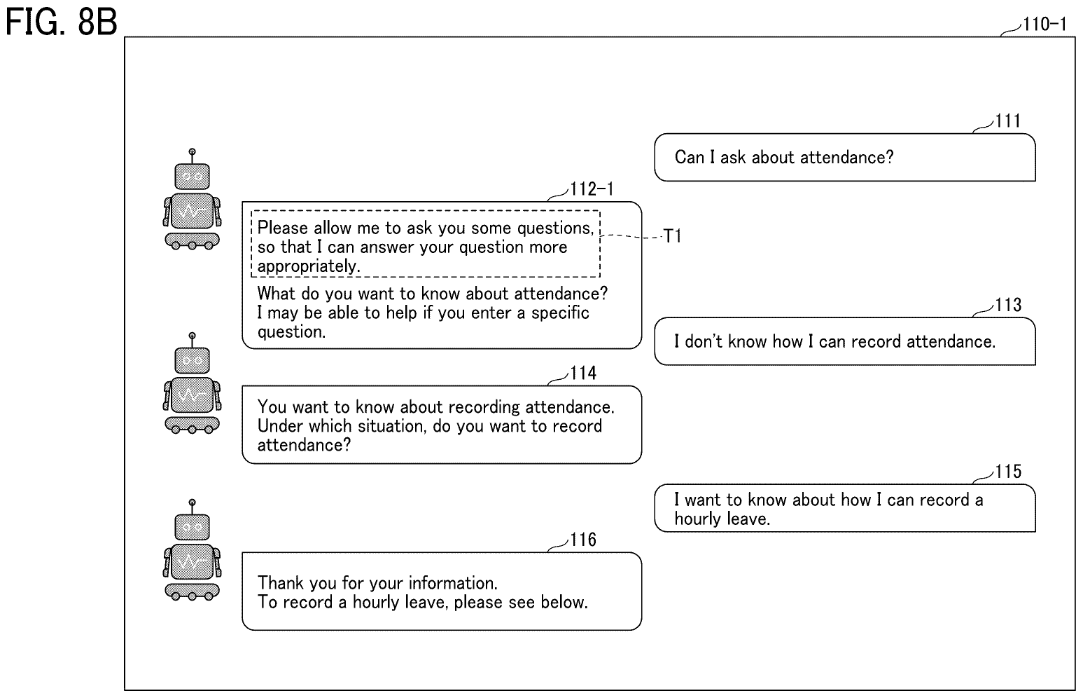

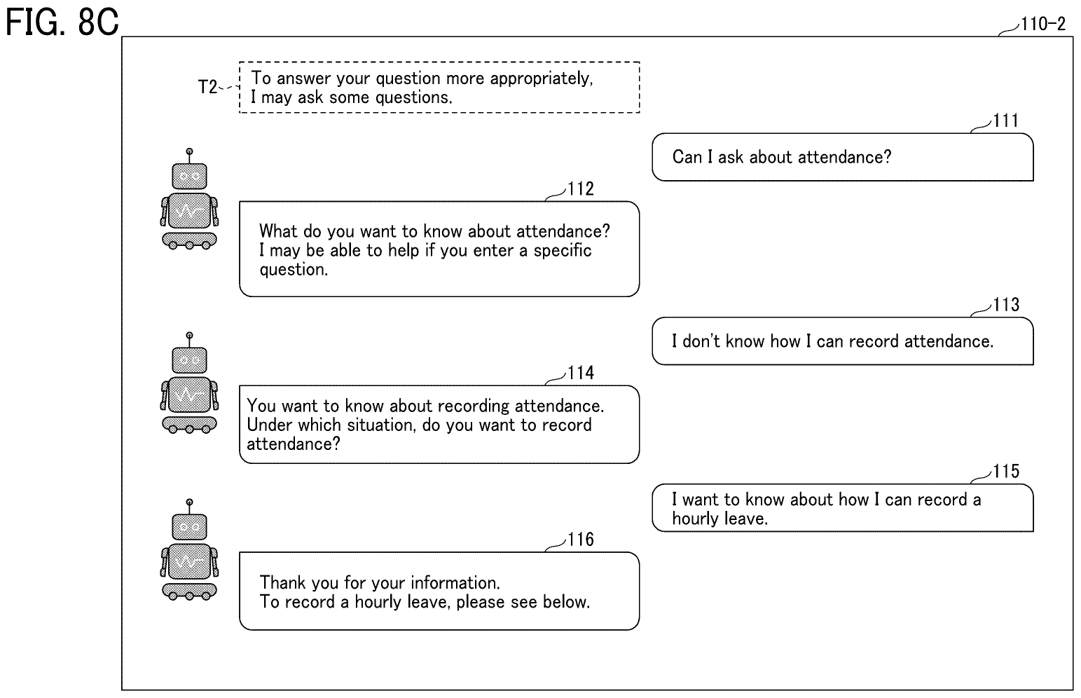

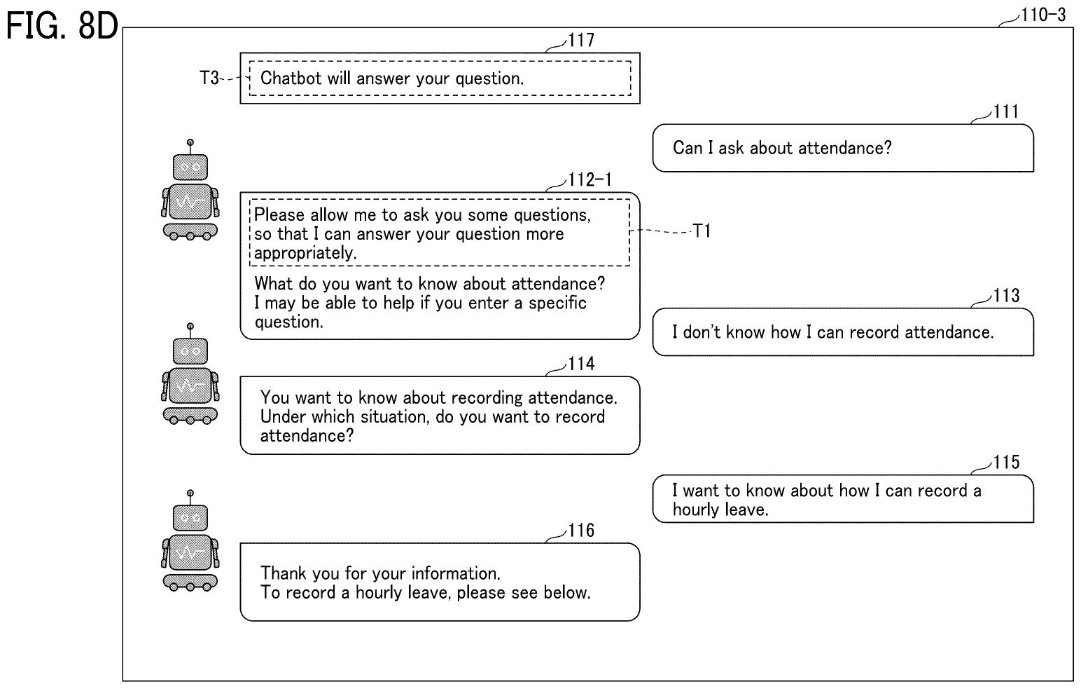

Example screens of the terminal apparatus 600 are described below with reference to FIGS. 8A to 8D. FIG. 8A is a first diagram illustrating an example screen displayed by the terminal apparatus 600.

A screen 110 illustrated in FIG. 8A is an example of a screen displayed at the terminal apparatus 600 at S611 of FIG. 6.

The screen 110 illustrated in FIG. 8A includes display areas 111 to 116. The display area 111 displays input question data input by the user of the terminal apparatus 600 at S601. The display area 112 displays text data indicating a question generated by the large-scale language model 511.

Specifically, the text data displayed in the display area 112 is output data output by the large-scale language model 511 in response to the input of the prompt 10 illustrated in FIG. 7. The display area 112 displays the text data indicating a question for prompting the user to input additional information.

The display area 113 displays text data, which is further input by the user of the terminal apparatus 600, as an answer to the question generated by the large-scale language model 511. The display area 113 displays additional input data, which is additionally input by the user.

The display area 114 displays text data indicating a question generated by the large-scale language model 511 based on the input question data displayed in the display area 111 and the additional input data (additional input question data) displayed in the display area 113.

The display area 115 displays additional input data, which is further input by the user in response to the question displayed in the display area 114.

The display area 116 displays output answer data including registered answer data, which is a search result of searching the question and answer DB 310 based on the input question data displayed in the display area 111, the additional input data displayed in the display area 113, and the additional input data displayed in the display area 115.

In the example of FIG. 8A, the options for the registered answer data, which are acquired when the input question data is input, are reduced to one registered answer data as a result of inputting the additional input data twice.

In the example of FIG. 8A, when two or more options of registered answer data are obtained through searching the question and answer DB 310 based on the input question data, the obtained options of registered answer data are not displayed at the terminal apparatus 600.

Alternatively, when two or more options of registered answer data are obtained through searching the question and answer DB 310 based on the input question data, the terminal apparatus 600 may display the options of registered answer data in association with the registered question data.

Further, the terminal apparatus 600 may notify the user of a reason the text data indicating the question for prompting the user to input additional information is displayed. In other words, the output unit 257 of the information processing apparatus 200 outputs, to the terminal apparatus 600, information indicating a reason for displaying a question prompting the additional input.

FIG. 8B is a second diagram illustrating an example screen displayed by the terminal apparatus 600.

A screen 110-1 illustrated in FIG. 8B displays notification text data T1, which is text data indicating the reason why the text data indicating the question for prompting the additional input is displayed. For example, the notification text data T1 includes a message “Please allow me to ask you some questions, so that I can answer your question more appropriately”. In the following description, text data indicating the reason why a question prompting additional input is displayed is referred to as the notification text data. In the display area 112-1 of FIG. 8B, the notification text data T1 is displayed above the text data indicating the question prompting the additional input.

As described above, with display of the notification text data on the screen 110-1 of the terminal apparatus 600, the user is less likely to be confused even though the user sees the question prompting the additional input.

The notification text data may have any message as long as it indicates the reason why the question prompting the additional input is displayed, so that the message is not limited to the example illustrated in FIG. 8B. In the example of FIG. 8B, the notification text data is displayed in the display area 112-1 together with the question for prompting the user to input additional information. Alternatively, the notification text data may be displayed in a display area other than the display area 112-1.

FIG. 8C is a third diagram illustrating an example screen displayed by the terminal apparatus 600. On a screen 110-2 illustrated in FIG. 8C, a notification text data T2 is displayed outside the display area 112. The notification text data T2 includes a message “To answer your question more appropriately, I may ask some questions.” In other words, the notification text data may be displayed in any area outside the display area, which is represented by a balloon. The notification text data may be displayed in any location on the screen 110-2.

Further, the user of the terminal apparatus 600 may be notified that the chatbot service provided by the chat system 100 answers the question of the user. FIG. 8D is a fourth diagram illustrating an example screen displayed by the terminal apparatus 600.

A screen 110-3 illustrated in FIG. 8D includes a display area 117 in addition to the display areas illustrated in the screen 110-1 of FIG. 8B. The display area 117 displays text data T3 including a message “Chatbot will answer your question”. The text data T3 of FIG. 8D is an example. The text data T3 displayed in the display area 117 may include any message notifying that the chatbot service will answer a question input by the user.

As described above, with the notification, the user can recognize that a partner with which the user is communicating is the chatbot service. Even if the response includes an answer not intended by the user, the user may understand why the response contains such data.

Example screens of the terminal apparatus 600 are described below when two or more options of registered question data are displayed.

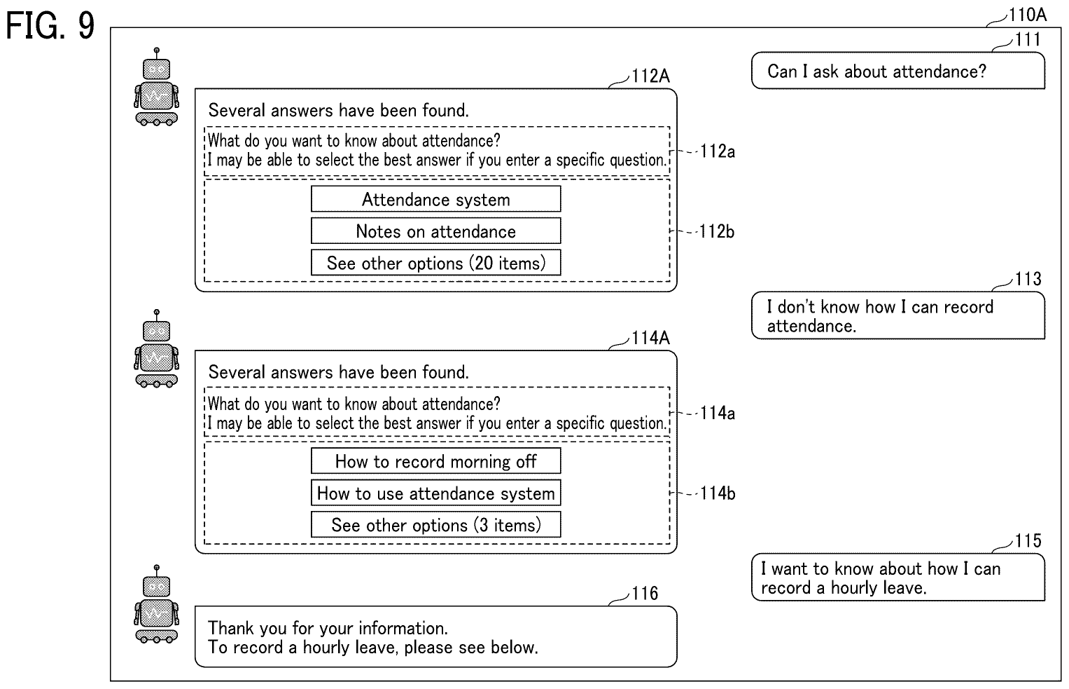

FIG. 9 is a fifth diagram illustrating an example screen displayed by the terminal apparatus 600. A screen 110A illustrated in FIG. 9 is an example of a screen displayed at the terminal apparatus 600 at S611 of FIG. 6.

The screen 110A illustrated in FIG. 9 includes display areas 111, 112A, 113, 114A, 115, and 116.

The display area 112A displays text data 112A for prompting the user to input additional input data, and a list 112b of registered question data similar to the input question data. The list 112b is obtained as a result of searching the question and answer DB 310 based on the input question data displayed in the display area 111.

The list 112b may display the registered question data in order, so that the registered question data having the higher degree of similarity to the input question data is displayed at the top. When the number of the registered question data obtained as the search result is greater than a number previously set, the list 112b may display the pre-set number of the registered question data, while displaying the other registered question data as “others”.

In the example of FIG. 9, when the user inputs the additional input data in the display area 113 without selecting the registered question data from the list 112b of the display area 112A, the terminal apparatus 600 transmits the additional input data to the information processing apparatus 200.

Alternatively, in the example of FIG. 9, the registered question data may be selected from the list 112b. When the registered question data is selected, the information processing apparatus 200 transmits registered answer data corresponding to the selected registered question data to the terminal apparatus 600 as output answer data.

The display area 114A displays text data 114a for prompting the user to input additional input data, and a list 114b of registered question data. The list 114b is obtained as a result of searching the question and answer DB 310 based on the input question data displayed in the display area 111 and the additional input data displayed in the display area 113.

In the example of FIG. 9, when the user inputs the additional input data in the display area 115 without selecting the registered question data from the list 114b of the display area 114A, the terminal apparatus 600 transmits the additional input data to the information processing apparatus 200.

Alternatively, in the example of FIG. 9, the registered question data may be selected from the list 114b. When the registered question data is selected, the information processing apparatus 200 transmits registered answer data corresponding to the selected registered question data to the terminal apparatus 600 as output answer data.

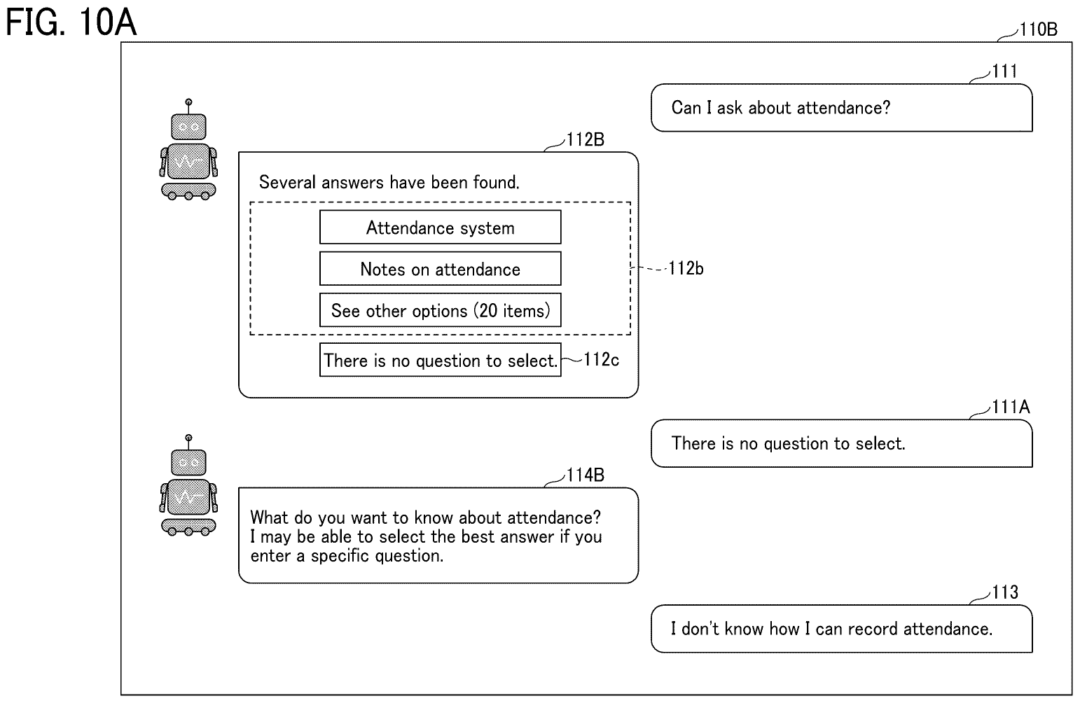

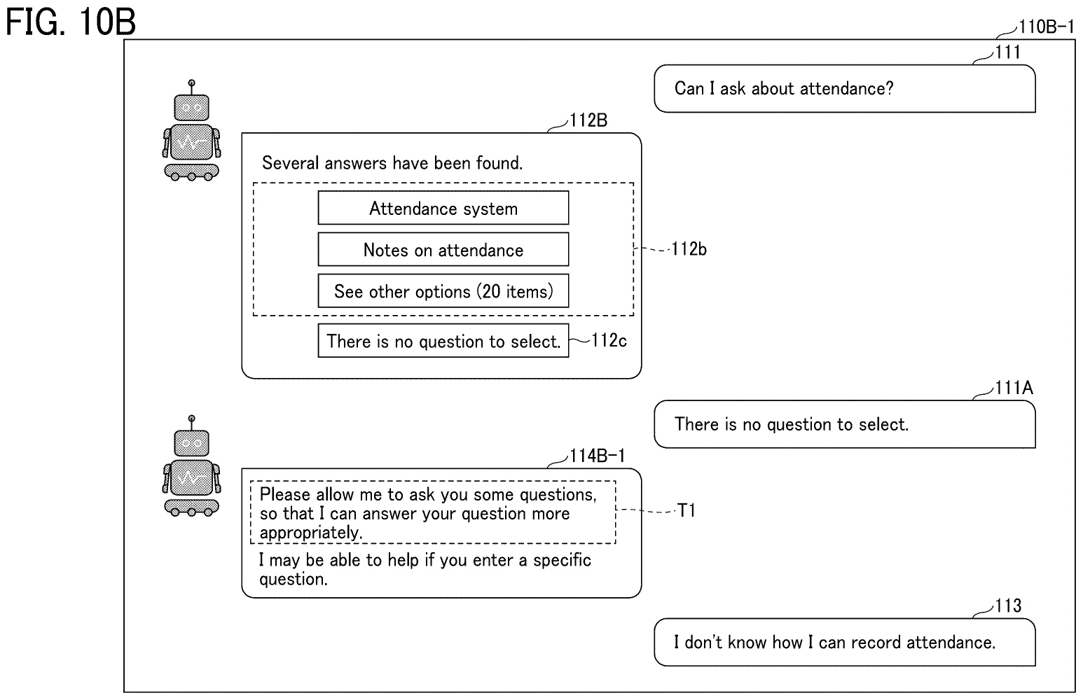

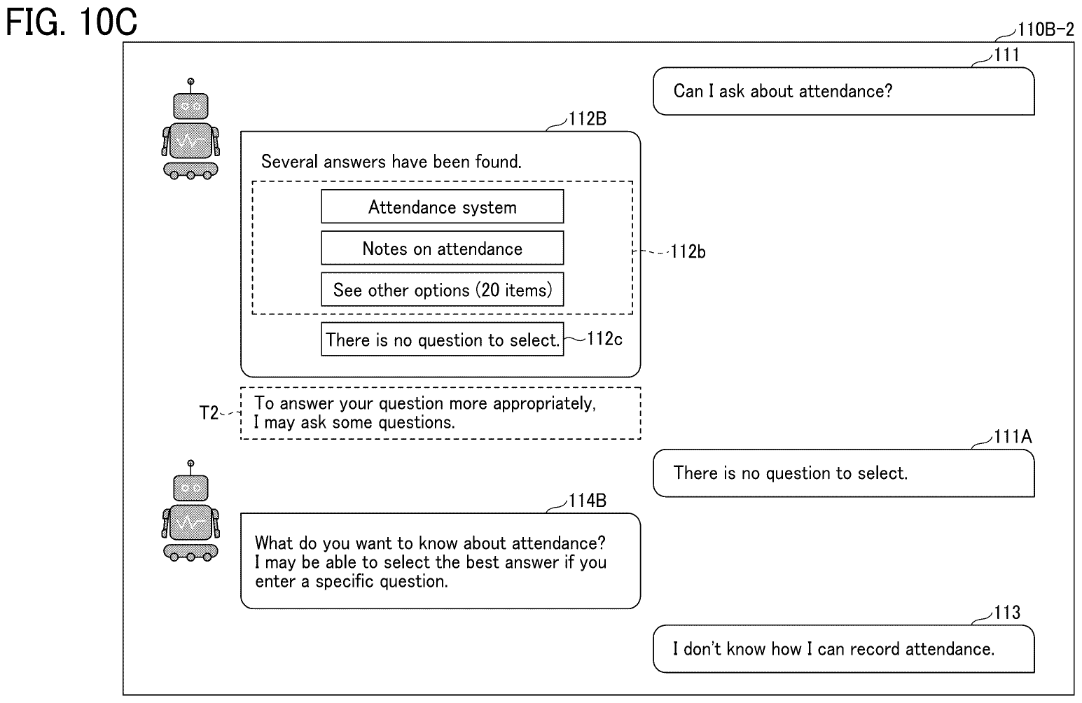

FIG. 10A is a sixth diagram illustrating an example screen displayed by the terminal apparatus 600. A screen 110B illustrated in FIG. 10A is an example of a screen displayed at the terminal apparatus 600 at S611 of FIG. 6.

The screen 110B illustrated in FIG. 10A includes display areas 111, 112B, 111A, 114B, and 113.

The display area 112B illustrated in FIG. 10A displays a list 112b of the registered question data similar to the input question data, and an operation button 112c. The operation button 112c is selected when the list 112b does not include the question intended by the user.

The display area 111A includes the option selected from the display area 112B. In the example of FIG. 10, the display area 112B displays text data indicating that the operation button 112c has been selected. The display area 114B displays text data prompting the user to input additional information.

As described above, when two or more records of registered question data similar to the input question data are obtained, the records of registered question data may be presented to the user of the terminal apparatus 600.

When a particular registered question data being displayed is selected, the registered answer data associated with the selected registered question data in the question and answer DB 310 may be output as the output answer data.

Further, in the example illustrated in FIG. 10A, the notification text data may be displayed in a substantially similar manner as described above for the examples of FIG. 8B and FIG. 8C. FIG. 10B is a seventh diagram illustrating an example screen displayed by the terminal apparatus 600. FIG. 10C is an eighth diagram illustrating an example screen displayed by the terminal apparatus 600.

In a screen 110B-1 of FIG. 10B, the notification text data T1 is displayed in a display area 114B-1 that displays the text data indicating the question prompting the user to input additional information.

In a screen 110B-2 of FIG. 10C, the notification text data T2 is displayed in an area other than display areas 112B and 114B represented by balloons.

With display of the notification text data, the user is less likely to be confused when using the chat system 100, thus enhancing the user operability of the chat system 100. Further, the text data T3 illustrated in FIG. 8D may be displayed in the screens of FIGS. 10A to 10C. The text data of FIG. 8D may be displayed on any of the example screens of the terminal apparatus 600 described below.

As described above, the chat system 100 can quickly present an answer to a question, as intended by the user.

### Second Example

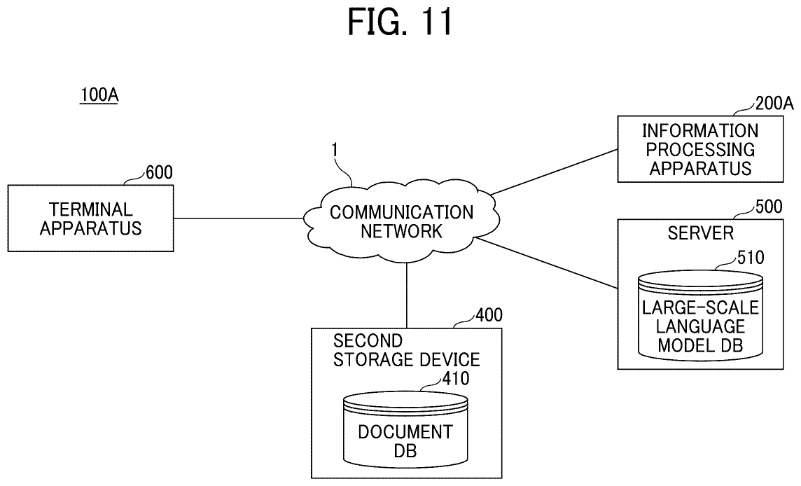

The chat system according to the second example is described below with reference to FIGS. 11 to 17. The second example is different from the first example in that the large-scale language model 511 included in the server 500 generates output answer data corresponding to input question data. In the following description of the second example, differences from the first example are described. The same reference numerals are given to the same or corresponding functions or configurations as those of the first example, and redundant descriptions thereof are omitted or simplified appropriately.

FIG. 11 is a diagram illustrating a system configuration of a chat system 100A.

The chat system 100A, which is an example of the information processing system, includes an information processing apparatus 200A, a second storage device 400, the server 500, and the terminal apparatus 600, which are connected to each other via a communication network 1.

In the chat system 100A, the information processing apparatus 200A, the second storage device 400, and the server 500 operate in cooperation to provide a chatbot service to the user of the terminal apparatus 600.

The second storage device 400 includes a document DB 410. The document DB 410, which is an example of a document storage unit, stores user-specific information specific to the user, such as private information that is not open to the public.

The user of the chat system 100 may be, for example, the tenant. In the case where the user is the tenant, the user-specific information is information specific to the tenant. Alternatively, the user of the chat system 100 may be an individual user. In the case where the user is the individual user, the user-specific information is information specific to the individual user.

In the following description, in-company information is used as an example of the user-specific information.

The document DB 410 may store the in-company information by each tenant. The document DB 410 will be described in detail below.

In response to receiving the input question data from the terminal apparatus 600, the information processing apparatus 200A searches the document DB 410 stored in the second storage device 400 based on the input question data. When two or more records, which can be an information source for an answer to the question, are obtained as a search result, the information processing apparatus 200A transmits to the server 500 a prompt for requesting generation of a question that requests the user of the terminal apparatus 600 to input additional information.

In the example of FIG. 11, the information processing apparatus 200A and the second storage device 400 are illustrated as separate devices, but any one of these apparatuses or devices may be combined into one apparatus or device. For example, the second storage device 400 may be included in the information processing apparatus 200A.

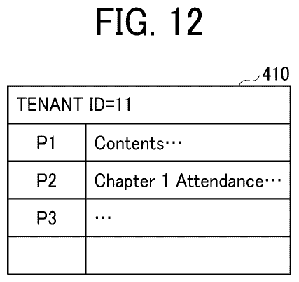

The document DB 410 of the second storage device 400 is described below with reference to FIG. 12. FIG. 12 is an example table illustrating the document DB 410.

FIG. 12 is an example table illustrating the document DB 410. The document DB 410 may store and manage in-company information for each tenant. FIG. 12 illustrates, as an example, in-company information that is managed for a particular tenant identified with a tenant ID “11”.

For example, the in-company information are divided into a number of preset units, and the divided units of the in-company information are separately stored in the document DB 410. In the following description, each divided unit of the in-company information is referred to as a chunk or chunk data. In the document DB 410, the chunk data may be stored in association with an identifier for identifying that chunk data.

In FIG. 12, one chunk is previously set to correspond to one page of the in-company information. The identifier identifying the chunk number is set to be the same as a page number of the particular page of the in-company information. The chunk data does not have to correspond to one page of the in-company document, and may correspond to, for example, one paragraph or one chapter of the in-company document.

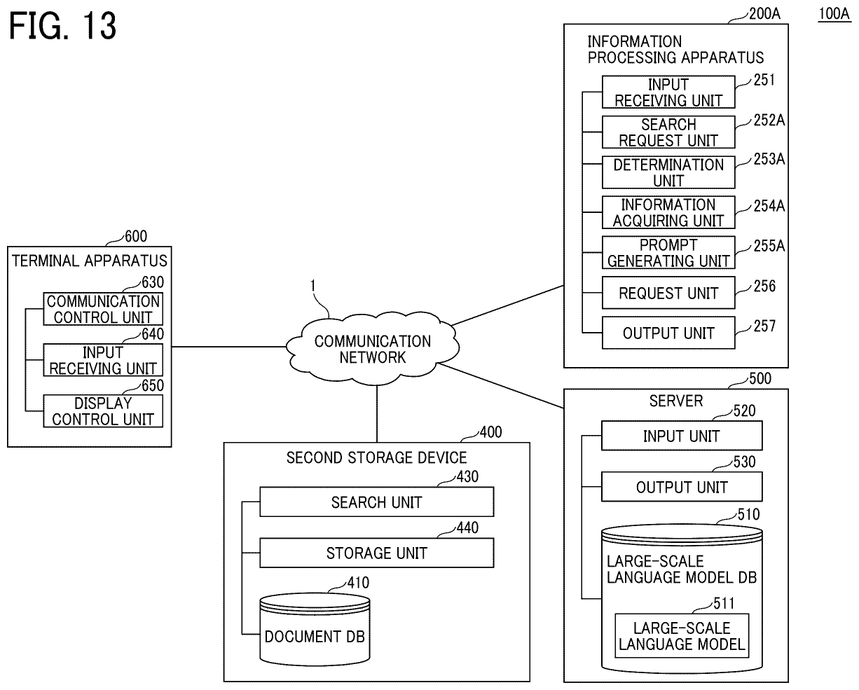

Example functional configurations of apparatus or devices included in the chat system 100A are described below with reference to FIG. 13. FIG. 13 is a diagram illustrating functional configurations of apparatuses or devices included in the chat system 100A.

First, the functional configuration of the information processing apparatus 200A is described below. The information processing apparatus 200A includes the input receiving unit 251, a search request unit 252A, a determination unit 253A, an information acquiring unit 254A, a prompt generating unit 255A, the request unit 256, and the output unit 257.

The input receiving unit 251 receives various inputs to the information processing apparatus 200. Specifically, the input receiving unit 251 receives inputs of input question data from the terminal apparatus 600.

The search request unit 252A requests the second storage device 400 to conduct search. Specifically, the search request unit 252 transmits, to the second storage device 400, a search request for searching the document DB 410 using the input question data as a search key.

The determination unit 253A determines whether the in-company information obtained using the input question data has a sufficient amount of information that is sufficient to generate the output answer data, based on the search result obtained by the search request unit 252A in response to the search request to the second storage device 400.

In other words, the determination unit 253A determines whether the amount of in-company information obtained from the second storage device 400 is equal to or greater than a predetermined amount.

When two or more chunks of in-company information are acquired as a result of searching the document DB 410 of the second storage device 400, the determination unit 253A determines that the amount of in-company information obtained using the input question data is equal to or greater than the predetermined amount of information.

In other words, the determination unit 253A determines that the information obtained using the input question data is insufficient when two or more chunks of in-company information are acquired as a result of searching the document DB 410 of the second storage device 400. The determination unit 253A further determines that the information obtained using the input question data is sufficient when one chunk of in-company information is acquired as a result of searching the document DB 410 of the second storage device 400.

The information acquiring unit 254A acquires, from the second storage device 400, the search result corresponding to the search request from the search request unit 252A. In other words, the information acquiring unit 254A acquires the chunk data as the search result from the second storage device 400.

The prompt generating unit 255A generates a prompt to be output to the server 500. The prompt generation unit 255A generates a prompt for requesting generation of an answer to the question indicated by the input question data. When the determination unit 253 determines that the information obtained using the input question data is insufficient, the prompt generating unit 255 generates a prompt for requesting generation of a question that causes the user to input additional input data.

The functional configuration of the second storage device 400 is described below. The second storage device 400 includes the document DB 410, a search unit 430, and a storage unit 440. The search unit 430 searches the document DB 410 in response to a search request from the information processing apparatus 200A, and transmits a search result to the information processing apparatus 200A. In response to an operation of uploading in-company information by the administrator of the chat system 100A, the storage unit 440 newly stores the in-company information in the document DB 410.

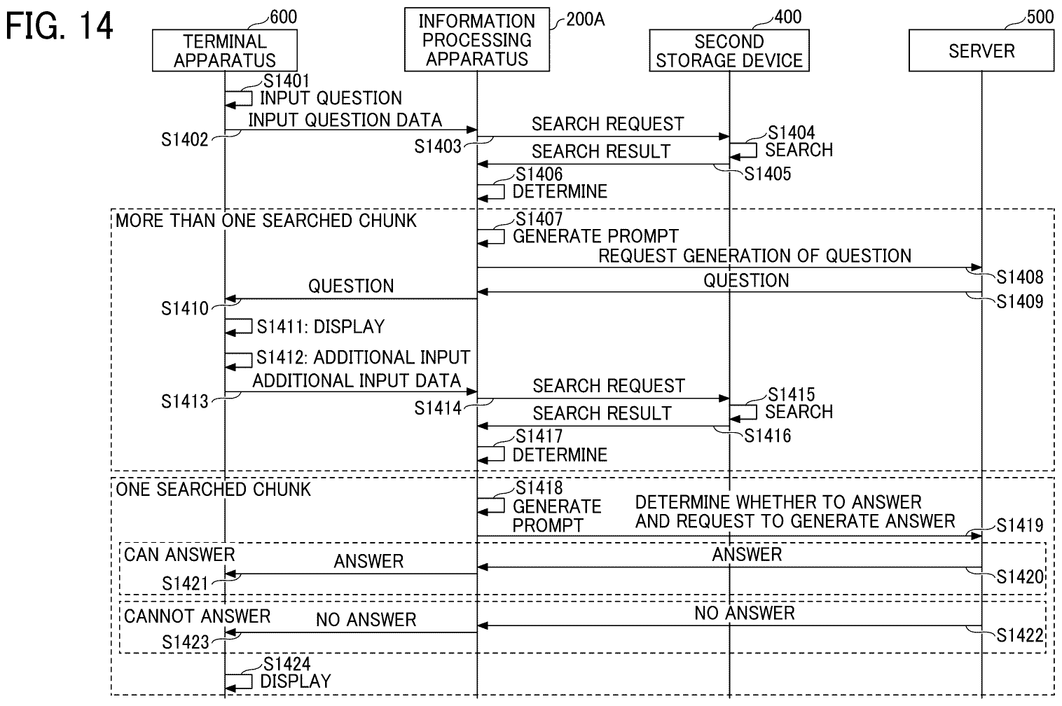

An example operation performed by the chat system 100A is described below with reference to FIG. 14. FIG. 14 is a sequence diagram illustrating an example operation performed by the chat system 100A.

In the chat system 100A, when the input receiving unit 640 receives an input of question data at S1401, the terminal apparatus 600 transmits the input question data to the information processing apparatus 200A at S1402. The input question data being transmitted may be assigned with a tenant ID identifying a tenant to which the user operating the terminal apparatus 600 belongs.

At S1403, in response to receiving the input question data by the input receiving unit 251, the search request unit 252A of the information processing apparatus 200A transmits a search request including the tenant ID to the second storage device 400.

When the second storage device 400 receives the search request, at S1404, the search unit 430 searches the document DB 410 to obtain a search result. At S1405, the search unit 430 transmits the search result to the information processing apparatus 200A. Specifically, the second storage device 400 searches the document DB 410 using the input question data as a search key, and acquires chunk data to be an information source for generating an answer.

When the information acquiring unit 254A of the information processing apparatus 200A acquires the search result from the second storage device 400, at S1406, the determination unit 253A determines whether the number of chunks of in-company information acquired as the search result is more than one. In other words, the determination unit 253A determines whether the number of chunks of in-company information acquired from the second storage device 400 is equal to or greater than a predetermined number. In this example, the predetermined number is set to 1.

When the number of chunks of in-company information acquired as the search result is one at S1406, the information processing apparatus 200A proceeds the operation to S1418 described below.

When the number of the chunks of in-company information acquired as the search result is two or more at S1406, at S1407, the prompt generating unit 255 of the information processing apparatus 200 generates a prompt for requesting generation of a question that causes the user of the terminal apparatus 600 to input additional information.

Since the processes from S1408 to S1413 of FIG. 14 are performed in a substantially similar manner as the processes from S608 to S613 of FIG. 6, the description thereof is omitted.

When the information processing apparatus 200A receives the input of additional data from the terminal apparatus 600, at S1414, the search request unit 252A transmits a search request to the second storage device 400, which requests to search using the input question data and the additional input as search keys.

Since the processes from S1415 to S1417 of FIG. 14 are performed in a substantially similar manner as the processes from S1403 to S1406 of FIG. 14, the description thereof is omitted.

In the example of FIG. 14, the processes from S1407 to S1417 are repeated until the number of chunks of in-company information acquired as the search result from the second storage device 400 becomes one.

When the number of chunks of in-company information acquired as the search result is one, at S1418, the prompt generating unit 255A of the information processing apparatus 200A generates a prompt for requesting generation of an answer when the answer can be generated based on the acquired chunk as a source of information. In other words, the prompt generated at S1418 is a prompt for requesting determination of whether the answer can be generated using the chunk as the information resource and generation of the answer when it is determined that the answer can be generated.

At S1419, the request unit 256 of the information processing apparatus 200A transmits the generated prompt to the server 500.

When the large-scale language model 511 determines that an answer can be generated and outputs the output data including the answer to the input question data, at S1420, the server 500 transmits the output data to the information processing apparatus 200A.

When the information processing apparatus 200A receives the output data including the answer from the server 500, at S1421, the output unit 257 transmits the output answer data including the answer to the terminal apparatus 600.

When the large-scale language model 511 determines that the answer cannot be generated, at S1422, the server 500 transmits output data indicating that the answer cannot be generated to the information processing apparatus 200A.

When the information processing apparatus 200A receives the output data including the answer from the server 500, at S1423, the output unit 257 transmits the output answer data indicating that the answer cannot be generated to the terminal apparatus 600.

At S1424, the display control unit 650 of the terminal apparatus 600 displays the output answer data on the display 618. When the server 500 determines that an answer can be generated, the terminal apparatus 600 displays the answer to the question indicated by the input question data. When the server 500 determines that an answer cannot be generated, the terminal apparatus 600 displays a message indicating that the answer cannot be generated.

In the example of FIG. 14, the processes from S1407 to S1417 are repeated until the number of chunks of in-company information acquired as the search result from the second storage device 400 becomes one. Alternatively, in the case where the number of chunks of in-company information does not become one even after the processes from S1407 to S1417 are repeated a predetermined number of times, the terminal apparatus 600 may display text data that encourages the user to contact the person in charge.

In other words, the output unit 257 of the information processing apparatus 200A outputs information indicating availability of a human operator to the terminal apparatus 600, when the number of chunks of in-company information does not become one even after the processes from S1407 to S1417 are repeated a predetermined number of times. At this time, the output unit 257 may output, to the terminal apparatus 600, a display instruction for causing the terminal apparatus 600 to display an operable component for switching to the service provided by the human operator.

In this case, the determination unit 253A of the information processing apparatus 200A may determine whether the processes from S1407 to S1417 have been repeated a predetermined number of times. The predetermined number of times may be, for example, two times. The predetermined number of times may be previously set, for example, by an administrator of the chat system 100A.

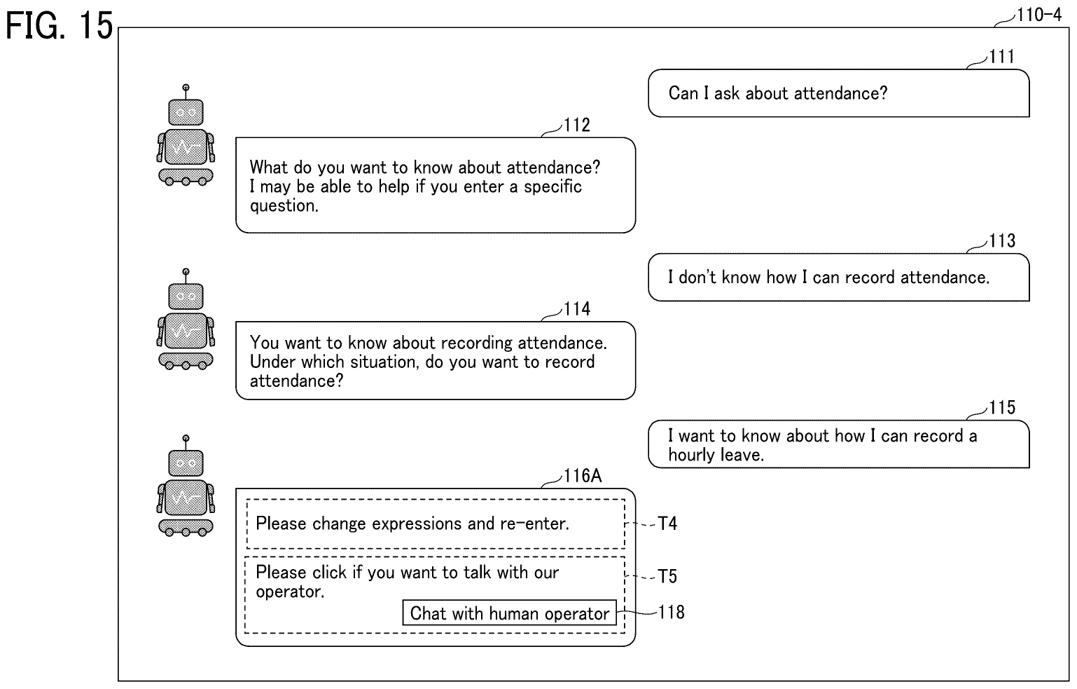

Example screen of the terminal apparatus 600 when the number of chunks does not become one is described below with reference to FIG. 15. FIG. 15 is a diagram illustrating an example screen displayed by the terminal apparatus 600.

A screen 110-4 illustrated in FIG. 15 may be displayed on the terminal apparatus 600, for example, when the number of chunks of in-company information does not become one even after repeating the processes from S1407 to S1417 of FIG. 14 twice.

The screen 110-4 includes display areas 111, 112, 113, 114, 115 and 116A. The display area 116A displays text data T4, text data T5, and an operation button 118. The text data T4 prompts the user to re-input a question in a different expression. The text data T5 indicates a contact destination for the question. The operation button 118 is for switching the chatbot service provided by the chat system 100A to the chat service provided by the human operator. The contents displayed in the display area 116A is not limited to the example illustrated in FIG. 15 as long as an operable component that allows the user to switch to the chat service provided by the human operator is included.

By allowing the user to switch to the chat service provided by the human operator, the chat system 100A does not have to repeatedly request the user to input the additional information by asking the counter-question.

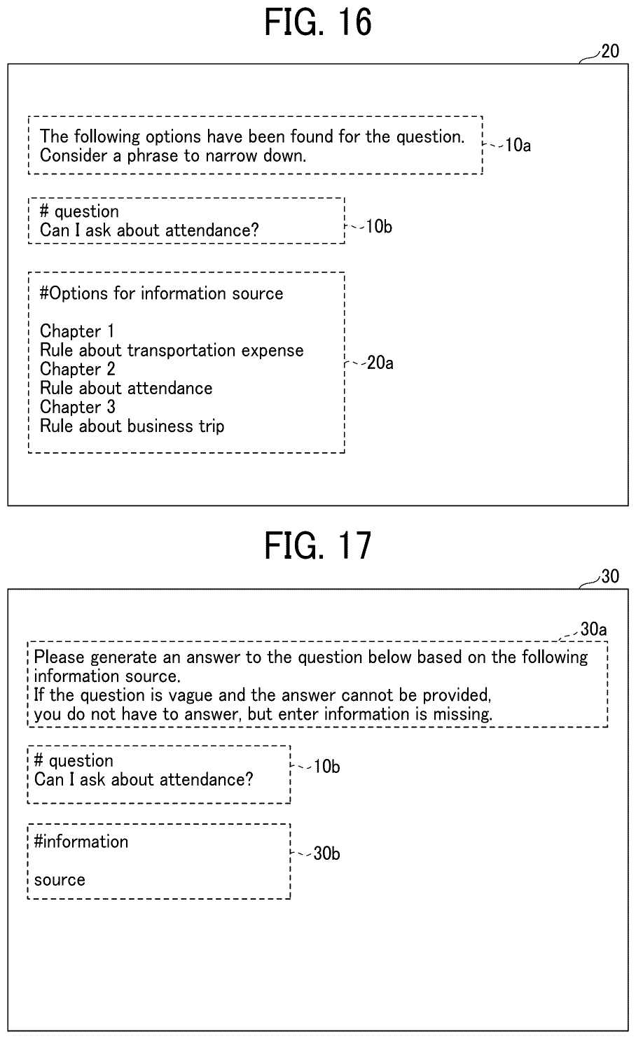

An example prompt generated by the prompt generating unit 255A is described below with reference to FIGS. 16 and 17.

FIG. 16 is a diagram illustrating an example prompt. FIG. 16 illustrates a prompt 20, which is an example of the prompt generated by the prompt generating unit 255A at S1407 of FIG. 14.

The prompt 20 includes text data 10a, text data 10b, and text data 20a. The text data 20a includes two or more chunks of in-company information. In other words, the chunks included in the text data 20a are chunks obtained as a search result of the document DB 410 using the input question data.

The prompt 20 causes the large-scale language model 511 to generate a question based on the search result of searching the document DB 410 using the input question data.

FIG. 17 is a diagram illustrating an example prompt. The prompt 30 illustrated in FIG. 17 includes text data 30a, 10b, and 30b.

The text data 30a requests to determine whether an answer can be generated using the chunk of in-company information as an information resource, generate an answer when the answer can be generated, and notify when the answer cannot be generated.

The text data 30b indicates a chunk of in-company information, which is a source of information used to generate an answer. In other words, the chunk included in the text data 30b is one chunk obtained as a search result of searching the document DB 410 using the input question data.

With generation of the prompt 20, the large-scale language model 511 is caused to generate an answer based on the search result of searching the document DB 410 using the input question data.

Further, each of the prompts 20 and 30 includes one chunk of in-company information as the information source, so that the amount of in-company information to be referred to as the information source is reduced before transmission to the server 500. Accordingly, the accuracy of the output data from the large-scale language model 511 is improved, while controlling the number of inputs to fit within the token limits of the large-scale language model 511.

### Third Example

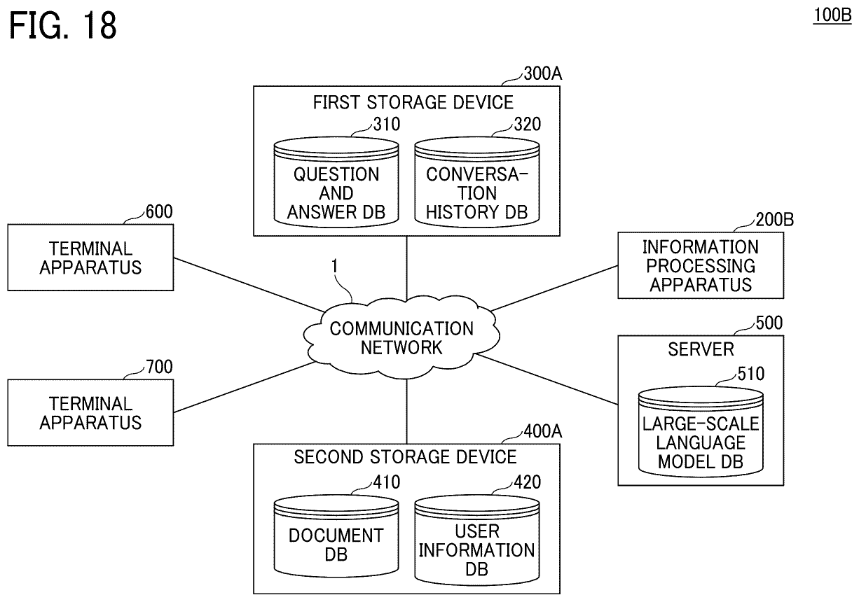

A chat system 100B according to the third example is described below with reference to FIGS. 18 to 20. The chat system 100B of the third example is different from the chat system 100 of the first example in that, when the registered question data corresponding to the input question data does not exist in the question and answer DB 310, such that the registered answer data cannot be obtained, the output answer data is generated by the large-scale language model 511. In the following description of the third example, differences from the first example are described. The same reference numerals are given to the same or corresponding functions or configurations as those of the first example, and redundant descriptions thereof are omitted or simplified appropriately.

FIG. 18 is a diagram illustrating a system configuration of the chat system 100B.

The chat system 100B, which is an example of the information processing system, includes an information processing apparatus 200B, a first storage device 300A, a second storage device 400A, the server 500, the terminal apparatus 600, and a terminal apparatus 700, which are connected to each other via the communication network 1.

The first storage device 300A includes the question and answer DB 310 and a conversation history DB 320. The conversation history DB 320, which is an example of a conversation storage history unit, stores conversation history information in which questions input from the terminal apparatus 600 are associated with answers output to the terminal apparatus 600. The conversation history information may be managed by each tenant that uses the chat system 100B. The tenant may be an organization to which a user who uses the chat system 100B belongs, such as a company that the user works for.

The second storage device 400A includes the document DB 410, and a user information DB 420. The user information DB 420 stores, for each tenant, user information regarding one or more users belonging to the tenant.

The terminal apparatus 700 is operated, for example, by an administrator who manages the chat system 100B. The question and answer information stored in the question and answer DB 310 of the first storage device 300A, the document information stored in the document DB 410 of the second storage device 400A, and the user information stored in the user information DB 420 may be stored in the respective storage areas by an administrator who is a user of the terminal apparatus 700.

In response to receiving an input of question data from the terminal apparatus 600, the information processing apparatus 200B searches the question and answer DB 310 of the first storage device 300A. When there is no registered answer data that corresponds to the input question data, the information processing apparatus 200B searches the document DB 410 of the second storage device 400A to acquire the chunk of in-company information to be referred to as the information resource. The information processing apparatus 200B generates a prompt for requesting generation of an answer using the chunk as the information source, and transmits the prompt to the server 500.

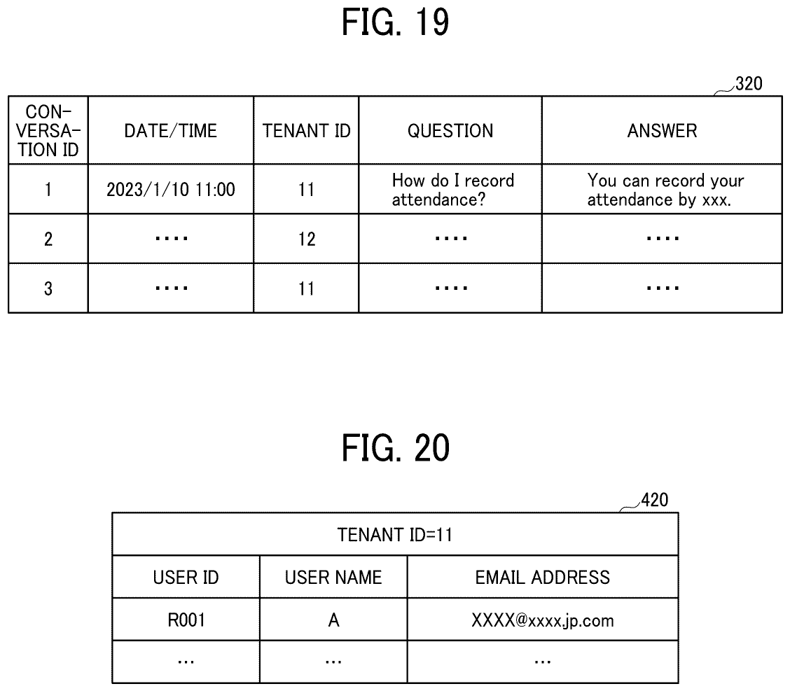

The conversation history DB 320 and the user information DB 420 are described below with reference to FIGS. 19 and 20.

FIG. 19 is a table illustrating an example conversation history DB. The conversation history information stored in the conversation history DB 320 illustrated in FIG. 19 includes, as data items, a conversation ID, date and time, a tenant ID, a question, and an answer, which are associated with one another.

The “conversation ID” item has a value, which is an identifier for identifying a conversation. The conversation includes a set of question and answer. The item “date and time” has a value indicating the date and time when the input question data is input to the terminal apparatus 600 or the date and time when the output answer data is output to the terminal apparatus 600. The item “tenant ID” has a value, which is an identifier for identifying a tenant to which the user operating the terminal apparatus 600 belongs. The terminal apparatus 600 is a particular terminal apparatus that has received the question input by the user.

The item “question” has a value indicating the input question data input to the terminal apparatus 600, and is expressed as a sentence including the question. The item “answer” has a value indicating the output answer data output to the terminal apparatus 600, and is expressed as a sentence including the answer.

In other words, the conversation history information includes one or more pieces of conversation history information each related to a conversation including a set of question and answer. Specifically, the conversation history information includes the conversation ID for identifying the conversation history information, the tenant ID of the tenant to which the user of the terminal apparatus 600 belongs, the date and time when the input question data is input or the date and time when the output answer data is output, the input question data, and the output answer data.

The data items of the conversation history information illustrated in FIG. 19 is one example, such that the conversation history information may include data items other than the data items illustrated in FIG. 19.

FIG. 20 is a table illustrating the user information DB 420. The user information DB 420 may store and manage in-company information for each tenant.

The user information includes, as data items, a tenant ID, a user ID, a user name, and an email address. The item “tenant ID” has a value, which is an identifier for identifying a tenant to which the user operating the terminal apparatus 600 belongs. The terminal apparatus 600 is a particular terminal apparatus that has received the question input by the user. The item “user ID” has a value, which is an identifier for identifying a user operating the terminal apparatus 600. The item “user name” has a value indicating the name of the user identified with the user ID. The item “email address” has a value indicating the email address of the user identified with the user ID.

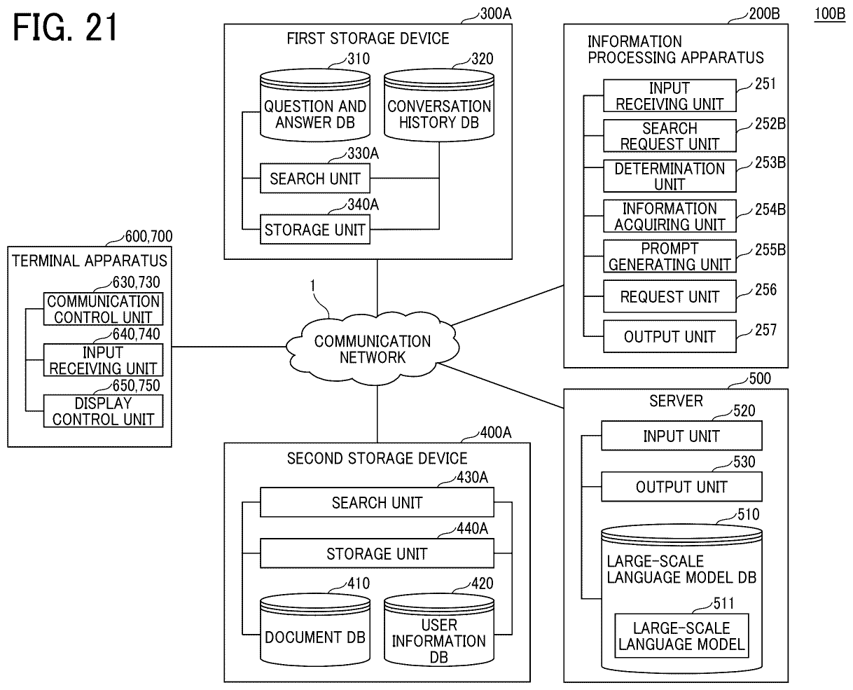

Functions of apparatus or devices included in the chat system 100B are described below with reference to FIG. 21. FIG. 21 is a diagram illustrating functional configurations of the apparatuses or devices included in the chat system 100B.

The functional configuration of the information processing apparatus 200B is described below. The information processing apparatus 200B includes the input receiving unit 251, a search request unit 252B, a determination unit 253B, an information acquiring unit 254B, a prompt generating unit 255B, the request unit 256, and the output unit 257.

The search request unit 252B requests the first storage device 300A or the second storage device 400A to conduct search using the input question data as a search key.

The determination unit 253B determines whether the amount of information acquired from the first storage device 300A based on the input question data is equal to or greater than a predetermined amount of information. The determination unit 253B further determines whether the amount of information acquired from the second storage device 400A based on the input question data is equal to or greater than a predetermined amount of information. The determination unit 253B further determines whether the information is acquired from the first storage device 300A based on the input question data.

Specifically, the determination unit 253B determines whether the registered answer data is acquired from the first storage device 300A. The determination unit 253B determines whether the registered question data acquired from the first storage device 300A includes two or more records. The determination unit 253B determines whether the number of chunks of in-company information acquired from the second storage device 400A is two or more.

The information acquiring unit 254B acquires a search result of searching the first storage device 300A. The information acquiring unit 254B further acquires the search result of searching the second storage device 400A.

The prompt generating unit 255B generates a prompt for requesting generation of a question to obtain additional input data, when two or more records of the registered answer data are obtained as a search result from the first storage device 300A. The prompt generating unit 255B further generates a prompt for requesting generation of a question to obtain additional input data, when two or more chunks of in-company information are obtained as a search result from the second storage device 400A. The prompt generating unit 255B generates a prompt for requesting determination of whether an answer to the question indicated by the input question data can be generated, requesting generation of an answer when the answer can be generated, and requesting transmission of a notification when the answer cannot be generated.

In other words, the information processing apparatus 200B searches the storage device to be referred to in response to receiving the input question data, and outputs to the server 500 a prompt for requesting generation of a question to obtain additional input data when the amount of information acquired as a search result is equal to or greater than a predetermined amount of information.

In this example, the first storage device 300A and the second storage device 400A are examples of storage devices to be referred to in response to receiving the input question data. The question and answer information stored in the question and answer DB 310 and the user-specific information stored in the document DB 410 are examples of information to be a source when generating the answer to the question indicated by the input question data.

The first storage device 300A includes a search unit 330A and a storage unit 340A. The search unit 330A searches the conversation history DB 320 or the question and answer DB 310 in response to a search request from the information processing apparatus 200B, and transmits a search result to the information processing apparatus 200B. When question data is input to the information processing apparatus 200B and output answer data is output from the information processing apparatus 200B, the storage unit 340A stores conversation history information including the question data and the output answer data in the conversation history DB 320.

The second storage device 400A includes a search unit 430A and a storage unit 440A. The search unit 430A searches the document DB 410 or the user information DB 420 in response to a search request from the information processing apparatus 200B, and transmits a search result to the information processing apparatus 200B. The storage unit 440A stores the document information and the user information input from the terminal apparatus 700, respectively, in the document DB 410 and the user information DB 420.

The terminal apparatus 700 includes a communication control unit 730, an input receiving unit 740, and a display control unit 750.

The communication control unit 730 controls communication between the terminal apparatus 700 and the information processing apparatus 200B.

The input receiving unit 740 receives an input to the terminal apparatus 700. The display control unit 750 controls display at the terminal apparatus 700.

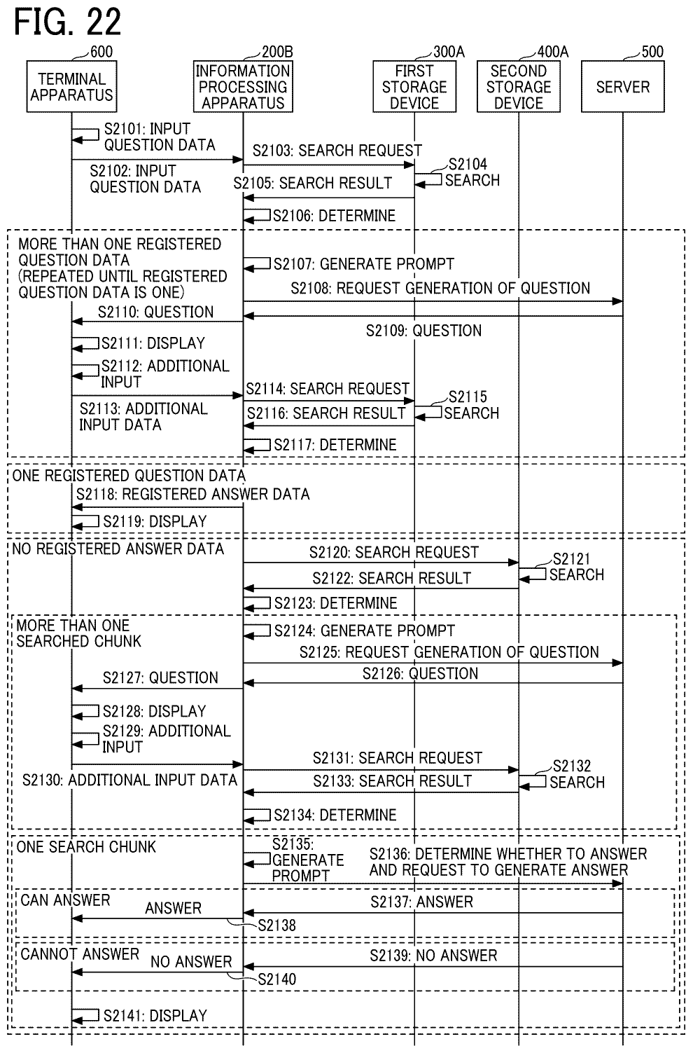

An example operation performed by the chat system 100B is described below with reference to FIG. 22. FIG. 22 is a sequence diagram illustrating an example operation performed by the chat system 100B.

In response to receiving an input of question data from the terminal apparatus 600, the information processing apparatus 200B searches the question and answer DB 310 of the first storage device 300A. When there is no registered answer data corresponding to the input question data in the question and answer DB 310, the information processing apparatus 200B obtains an answer to the question indicated by the input question data by using the large-scale language model 511.

Since the processes from S2101 to S2105 of FIG. 22 are performed in a substantially similar manner as the processes from S601 to S605 of FIG. 6, the description thereof is omitted.

At S2106, performed after S2105, the determination unit 253B of the information processing apparatus 200B determines whether the registered answer data has been acquired at S2104. When the registered answer data has been acquired, the determination unit 253B further determines whether two or more records are obtained as the registered answer data.

When the registered answer data is not obtained at S2106, that is, when the registered answer data corresponding to the input question data is not stored in the question and answer DB 310, the information processing apparatus 200B proceeds the operation to S2120.

When the registered answer data is obtained and the number of records of the registered answer data is one at S2106, the information processing apparatus 200B proceeds the operation to S2118 described below.

When the registered answer data is obtained and the number of records of the registered answer data is two or more at S2106, the information processing apparatus 200B proceeds the operation to S2107 described below.

Since the processes from S2107 to S2117 of FIG. 22 are performed in a substantially similar manner as the processes from S607 to S617 of FIG. 6, the description thereof is omitted. The processes from S2107 to S2117 are repeated until the number of the registered answer data acquired as the search result from the first storage device 300A becomes one.

When the number of the registered answer data obtained as the search result is one at S2106, the information processing apparatus 200B determines that the operation proceeds to S2118 described below. Since the processes of S2118 and S2119 of FIG. 22 are performed in a substantially similar manner as the processes of S618 and S619 of FIG. 6, the description thereof is omitted.

When the registered answer data is not obtained at S2106, at S2120, the search request unit 252B of the information processing apparatus 200B transmits a search request to the second storage device 400A.

At S2120, the search request unit 252B may acquire conversation history information, which as obtained immediately before the input question data is input, from the conversation history DB 320, and transmit a search request including the input question data and the acquired conversation history information to the second storage device 400A.

Since the processes from S2120 to S2141 of FIG. 22 are performed in a substantially similar manner as the processes from S1403 to S1424 of FIG. 14, the description thereof is omitted.

With the search request including the conversation history information, the chunk related to the conversation history information is obtained as an information source to be referred to when generating an answer. The answer to the question is generated based on the conversation history information, such that the generated answer relates to the conversation history. For example, the answer having the same contents as the answer that is output immediately before may be given with a low priority. In another example, the answer satisfying the user may be given with a high priority, based on the contents of the user's question or the timing when the user's question is input. Accordingly, the answer that is more accurate is output in response to the question.

As described above, when there is no registered answer data corresponding to the input question data in the question and answer information stored in the question and answer DB 310, the large-scale language model 511 is used.

Accordingly, even when the question and answer information is not stored in the question and answer DB 310, the answer to the question indicated by the input question data is presented to the user by using the large-scale language model 511.

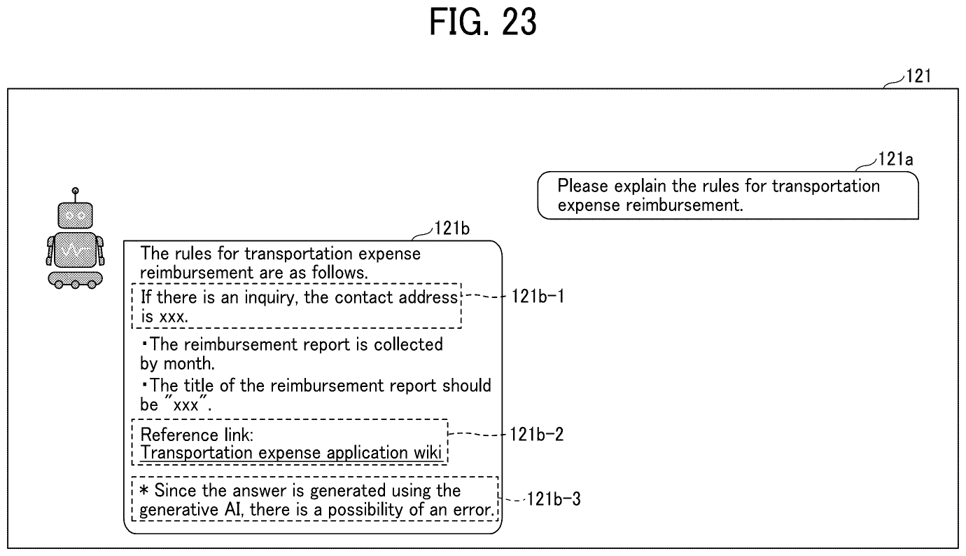

The operation of displaying output answer data is described with reference to FIGS. 23 to 25.

FIG. 23 is a diagram illustrating an example screen displayed by the terminal apparatus 600.

A screen 121 illustrated in FIG. 23 is an example of a screen displayed at the terminal apparatus 600 at S2141 of FIG. 22.

The screen 121 includes display areas 121a and 121b. The display area 121a displays the input question data input by the user of the terminal apparatus 600. The display area 121b displays text data 121b-1, a link 121b-2, and text data 121b-3, in addition to the output answer data output from the chat system 100.

The text data 121b-1 includes information indicating a contact address to be used by the user of the terminal apparatus 600 to send the additional question. The information indicating the contact address may be, for example, an email address or a telephone number. The information indicating the contact address may be stored, for example, in the user information DB 420. The user information DB 420 may store information indicating a task assigned to each user in association with the user ID of each user.

When transmitting the output answer data to the terminal apparatus 600, the information processing apparatus 200B may acquire the email address of the user in charge of the task, which corresponds to the question indicated by the input question data, and transmit the acquired email address to the terminal apparatus 600 together with the output answer data.

The link 121b-2 is a link for displaying information related to the contents indicated by the input question data and the output answer data.

The text data 121b-3 includes a message “Since the answer is generated using the generative AI, there is a possibility of an error”. With the display of the text data 121b-3, the chat system 100B notifies the user that there are no guarantees that the answer will be accurate or up-to-date.

The message included in the text data 121b-3 illustrated in FIG. 23 is an example, such that any other message may be included. The text data 121b-3 may include any message or expression other than the example illustrated in FIG. 23, as long as the text data 121b-3 includes information indicating that the answer to the question has been generated by the generative AI and that the answer may be incorrect or inappropriate.

By notifying the user of the terminal apparatus 600 of the contact address for further question and the information related to the question and the answer together with the output answer data, the user can be highly satisfied with the answer.

The information processing apparatus 200B may transmit a notification indicating that the question has been received from the user of the terminal apparatus 600, to the contact address included in the text data 121b-1. With the notification, the information processing apparatus 200 prompts a user, who is the contact destination, to prepare for responding to the additional question.

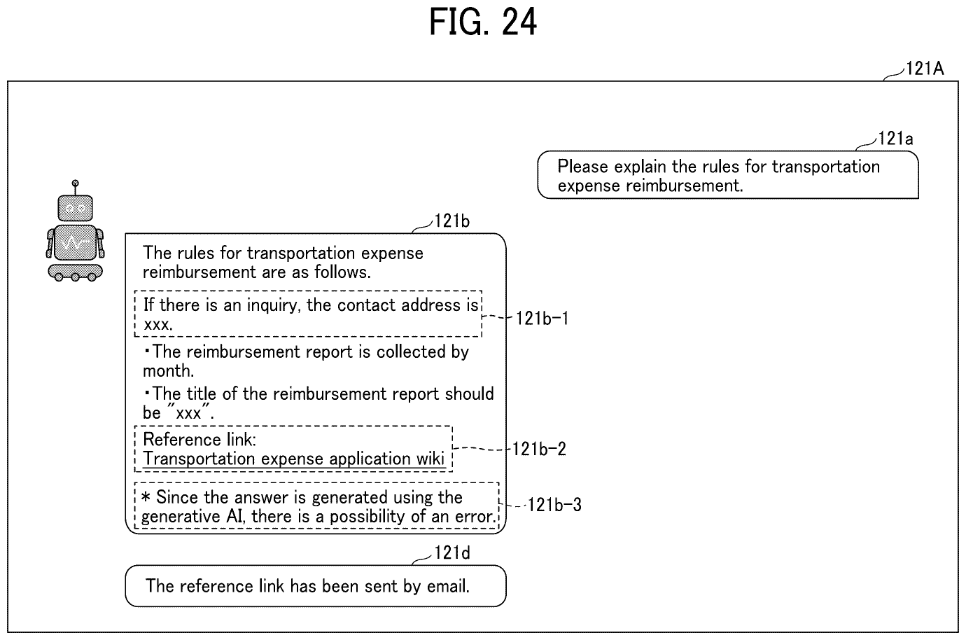

FIG. 24 is a diagram illustrating an example screen including the output answer data, which is displayed by the terminal apparatus 600. A screen 121A illustrated in FIG. 24 is another example of the screen displayed on the terminal apparatus 600 at S2141 of FIG. 22.

The screen 121A includes display areas 121a, 121b, and 121d. The display area 121d displays a message notifying that the link 121b-2 displayed in the display area 121b has been transmitted to the email address of the user of the terminal apparatus 600.

In this case, the user ID of the user of the terminal apparatus 600 may be input to the information processing apparatus 200B together with the input question data. The information processing apparatus 200B may refer to the user information DB 420 and acquire the email address identified using the tenant ID and the user ID. The information processing apparatus 200B may transmit the link 121b-2 to the identified email address together with the output answer data when transmitting the output answer data to the terminal apparatus 600, and then display the display area 121d on the terminal apparatus 600.

In the example of FIG. 24, with the transmission of the link 121b-2 for displaying the information related to the user's question to the user's email address, the user can refer to the information related to the question even after the user finishes using the chat system 100B.

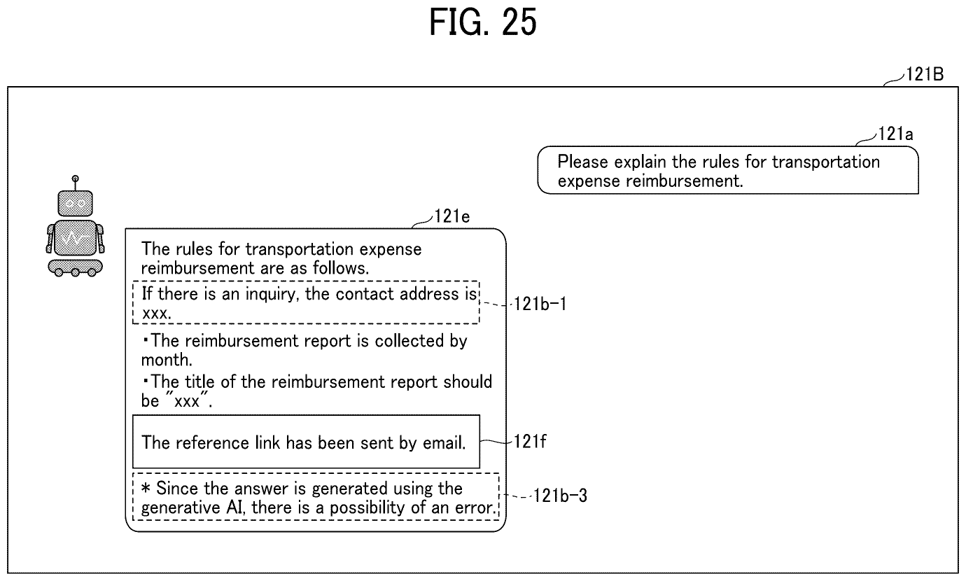

FIG. 25 is a diagram illustrating an example screen including the output answer data, which is displayed by the terminal apparatus 600. A screen 121B illustrated in FIG. 25 is another example of the screen displayed on the terminal apparatus 600 at S2141 of FIG. 22.

The screen 121B includes display areas 121a and 121e. The display area 121e includes text data 121b-1 indicating a contact address that the user of the terminal apparatus 600 can send an inquiry, and a message 121f.

The message 121f is a message indicating that a link for displaying information related to the user's question has been transmitted to the user's email address.

In the example of FIG. 25, the user can be notified of a link for displaying information related to the user's question separately from the output answer data.

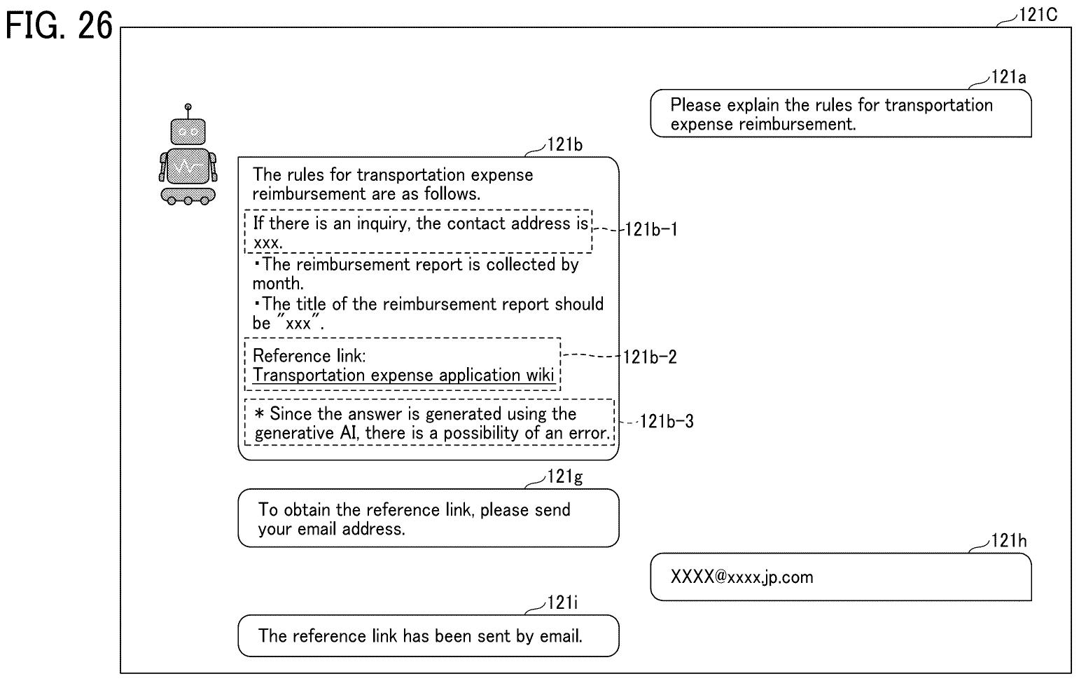

FIG. 26 is a diagram illustrating an example screen including the output answer data, which is displayed by the terminal apparatus 600. A screen 121C illustrated in FIG. 25 is another example of the screen displayed on the terminal apparatus 600 at S2141 of FIG. 22. The screen 121C may be displayed when the user's email address is not stored in the user information DB 420 of the second storage device 400A.

The screen 121C includes display areas 121a, 121b, 121g, 121h, and 121i. The display area 121g displays a message requesting a transmission destination of the link 121b-2.

The display area 121h displays an email address input by the user. The display area 121i displays a message notifying that the link 121b-2 has been transmitted to the email address input by the user.

In the example of FIG. 26, even when the email address of the user is not stored in the user information DB 420, the link 121b-2 can be transmitted to an address input by the user if the user desires.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Further, in any one of the above-described examples, the information processing apparatus determines whether the number of answer data acquired using the input question data is greater than the predetermined number to determine whether the answer can be generated. Alternatively, the information processing apparatus may determine whether the number of question data acquired using the input question data is greater than the predetermined number, especially in the first example where the registered question data is stored in association with the registered answer data.

The apparatuses or devices described in each embodiment are merely one example of plural computing environments that implement one or more embodiments disclosed herein.

In some embodiments, the information processing apparatus (200, 200A, 200B) includes multiple computing devices, such as a server cluster. The multiple computing devices are configured to communicate with each other over any type of communication link, including a network, a shared memory, etc. to collectively perform the processes disclosed herein. In substantially the same manner, the server 500, the first storage device (300, 300A) and the second storage device (400, 400A) can each include multiple computing devices configured to communicate with one another.

Further, the information processing apparatus (200, 200A, 200B) may be configured to share the processing steps disclosed herein in various combinations. For example, the processes executed by one or more functional units of the information processing apparatus may be performed by any one of the computing devices operating as the information processing apparatus. The functional elements of the information processing apparatus may be integrated into one server apparatus or may be divided into a plurality of apparatuses.

The information processing apparatus (200, 200A, and 200B) may be any apparatus having a communication function. Other examples of the information processing apparatus 200 include, but not limited to, an output device such as a Projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

The example aspects of the present disclosure are as follows.

According to Aspect 1, an information processing apparatus includes: an input receiving unit that receives input question data; an output unit that outputs, to a terminal apparatus, registered answer data associated with registered question data identified based on a question indicated by the input question data; and a request unit that requests a large-scale language model to generate a question for obtaining additional input question data when a number of the registered answer data identified based on the question is equal to or greater than a predetermined number. The output unit outputs, to the terminal apparatus, the question for obtaining the additional input question data, which is output from the large-scale language model.

According to Aspect 2, in the information processing apparatus according to Aspect 1, the registered answer data associated with the identified registered question data is stored in a first storage device.

According to Aspect 3, in the information processing apparatus according to Aspect 2, the input receiving unit receives an input of the additional input question data. The request unit further requests the large-scale language model to generate another question for obtaining the additional input question data when a number of registered answer data obtained from the first storage device based on the input question data and the additional input question data is equal to or greater than the predetermined number.

According to Aspect 4, in the information processing apparatus according to Aspect 2 or Aspect 3, the requesting unit requests the large-scale language model to generate the question for obtaining the additional input question data, when a plurality of records of the registered question data are obtained as a result of searching the first storage device based on the input question data.

According to Aspect 5, in the information processing apparatus of any one of Aspect 1 to Aspect 4, the request unit requests the large-scale language model to generate the question for obtaining the additional input question data when two or more chunks of user-specific information are obtained as a result of searching a second storage device based on the input question data, the second storage device storing a plurality of chunks of user-specific information including the two or more chunks of user-specific information.

According to Aspect 6, in the information processing apparatus of Aspect 5, the output unit outputs, to the terminal apparatus, an instruction to display an operable component that allows the user to switch to a chat service provided by a human operator, when the question for obtaining the additional input question data is output to the terminal apparatus a predetermined number of times.

According to Aspect 7, in the information processing apparatus of Aspect 6, when only one chunk of user-specific information is obtained as a result of searching the second storage device, the request unit further requests the large-scale language model to determine whether tan answer can be generated based on the one chunk of user-specific information, generate an answer based on a determination that the answer can be generated, and send a notification based on a determination that the answer cannot be generated. The output unit outputs the output data output from the large-scale language model to the terminal apparatus.

According to Aspect 8, in the information processing apparatus of any one of Aspect 2 to Aspect 7, when the registered question data is not obtained as a result of searching the first storage device, and when two or more chunks of user-specific information are obtained as a result of searching a second storage device storing a plurality of chunks of user-specific information including the two or more chunks of user-specific information, the request unit requests the large-scale language model to generate a question for obtaining the additional input question data.

According to Aspect 9, in the information processing apparatus of any one of Aspect 1 to Aspect 8, the output unit outputs to the terminal apparatus information indicating a reason why the question for obtaining the additional input question data is displayed.

According to Aspect 10, an information processing system includes an information processing apparatus and a terminal apparatus communicably connected with the information processing apparatus. The information processing apparatus includes: an input receiving unit that receives an input of question data; an output unit that outputs, to a terminal apparatus, registered answer data associated with registered question data identified based on a question indicated by the input question data; and a request unit that requests a large-scale language model to generate a question for obtaining additional input question data when a number of the registered answer data identified based on the question is equal to or greater than a predetermined number. The output unit outputs, to the terminal apparatus, a question for obtaining the additional input question data, which is output from the large-scale language model. The terminal apparatus includes a display control unit that displays a question for obtaining the additional input question data.

According to Aspect 11, an information processing method is performed by an information processing system including an information processing apparatus and a terminal apparatus communicably connected with the information processing apparatus. The information processing apparatus performs a method including: receiving input question data; outputting, to a terminal apparatus, registered answer data associated with registered question data identified based on a question indicated by the input question data; and requesting a large-scale language model to generate a question for obtaining additional input question data when a number of the registered answer data identified based on the question is equal to or greater than a predetermined number. The terminal apparatus performs a method including: displaying a question for obtaining the additional input question data. The outputting includes: outputting, to the terminal apparatus, a question for obtaining the additional input question data, which is output from the large-scale language model.

According to Aspect 12, a program causes an information processing apparatus to perform a method including: receiving input question data; outputting, to a terminal apparatus, registered answer data associated with registered question data identified based on a question indicated by the input question data; and requesting a large-scale language model to generate a question for obtaining additional input question data when a number of the registered answer data identified based on the question is equal to or greater than a predetermined number. The outputting includes: outputting, to the terminal apparatus, a question for obtaining the additional input question data, which is output from the large-scale language model.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising
circuitry configured to:
receive input question data from a terminal apparatus;
determine whether a number of answer data obtained based on a question indicated by the input question data is equal to or greater than a predetermined number;
output to the terminal apparatus answer data, based on a determination that the number of answer data obtained is less than the predetermined number; and
request a large-scale language model to generate a question for obtaining additional input question data and output to the terminal apparatus the question for obtaining the additional input question data output from the large-scale language model, based on a determination that the number of answer data obtained is equal to or greater than the predetermined number.

2. The information processing apparatus according to claim 1, wherein the circuitry is configured to:
search a first storage device based on the input question data, the first storage device storing a plurality of sets of registered answer data and registered question data; and
obtain, as the answer data, registered answer data associated with registered question data specified by the question indicated by the input question data.

3. The information processing apparatus according to claim 2, wherein, when the number of answer data obtained is equal to or greater than the predetermined number, the circuitry is further configured to:
receive additional input question data from the terminal apparatus; and
further request the large-scale language model to generate another question for obtaining additional input question data when a number of answer data obtained from the first storage device based on the input question data and the additional input question data is equal to or greater than the predetermined number.

4. The information processing apparatus according to claim 2, wherein the circuitry is configured to
determine that the number of answer data obtained is equal to or greater than the predetermined number, when a plurality of records of registered answer data are obtained as a result of searching the first storage device based on the input question data.

5. The information processing apparatus according to claim 1, wherein the circuitry is further configured to:
search a second storage device based on the input question data, the second storage device storing a plurality of chunks of user-specific information;
obtain, as the answer data, at least one chunk of user-specific information based on the question indicated by the input question data; and
determine that the number of answer data obtained is equal to or greater than the predetermined number, when two or more chunks of user-specific information are obtained as a result of searching the second storage device based on the input question data.

6. The information processing apparatus according to claim 5, wherein the circuitry is further configured to
output to the terminal apparatus an instruction to display an operable component that allows a user to switch to a chat service provided by a human operator, when the question for obtaining the additional input question data is output to the terminal apparatus a predetermined number of times.

7. The information processing apparatus according to claim 6, wherein the circuitry is further configured to:
determine that the number of answer data obtained is less than the predetermined number, when only one chunk of user-specific information is obtained as a result of searching the second storage device;
request the large-scale language model to determine whether an answer can be generated based on the one chunk of user-specific information, generate an answer based on a determination that the answer can be generated, and send a notification based on a determination that the answer cannot be generated; and
output the answer data to the terminal apparatus, the answer data being output from the large-scale language model in response to the request.

8. The information processing apparatus according to claim 2, wherein when no answer data is obtained as a result of searching the first storage device, the circuitry is further configured to:
search a second storage device based on the input question data, the second storage device storing a plurality of chunks of user-specific information; and
when two or more chunks of user-specific information are obtained as a result of searching the second storage device, the circuitry is configured to request the large-scale language model to generate a question for obtaining the additional input question data.

9. The information processing apparatus according to claim 1, wherein the circuitry is further configured to
output, to the terminal apparatus, information indicating a reason why the question for obtaining the additional input question data is displayed.

10. An information processing system comprising:
the information processing apparatus according to claim 1; and
the terminal apparatus configured to communicate with the information processing apparatus via a network,
the terminal apparatus including circuitry configured to display, on a display, the question for obtaining the additional input question data.

11. An information processing method, comprising:
receiving input question data;
determining whether a number of answer data obtained based on a question indicated by the input question data is equal to or greater than a predetermined number;
outputting answer data, based on a determination that the number of answer data obtained is less than the predetermined number; and
outputting a question for obtaining additional input question data output from a large-scale language model in response to a request for generating the question for obtaining additional input question data, based on a determination that the number of answer data obtained is equal to or greater than the predetermined number.

12. A non-transitory recording medium storing a plurality of instructions which, when executed by one or more processors, cause the processors to perform an information processing method comprising:
receiving input question data;
determining whether a number of answer data obtained based on a question indicated by the input question data is equal to or greater than a predetermined number;
outputting answer data, based on a determination that the number of answer data obtained is less than the predetermined number; and
outputting a question for obtaining additional input question data output from a large-scale language model in response to a request for generating the question for obtaining additional input question data, based on a determination that the number of answer data obtained is equal to or greater than the predetermined number.
